(19) United States
(12) Patent Application Publication
(10) Pub. No.: US 2018/0050754 A1
(43) Pub. Date: Feb. 22, 2018

(54) MOTORCYCLE AND VEHICLE SYSTEMS

(71) Applicant: Vanguard Moto Inc., Brooklyn, NY (US)

(72) Inventor: Edward Jacobs, Brooklyn, NY (US)

(21) Appl. No.: 15/680,869

(22) Filed: Aug. 18, 2017

Related U.S. Application Data
(60) Provisional application No. 62/378,178, filed on Aug. 22, 2016.
(60) Provisional application No. 62/378,721, filed on Aug. 24, 2016.

(51) Int. Cl. B62K 11/04; B62K 25/20; B62K 25/06; B62J 1/08; B62J 25/00; B62J 35/00; B62J 6/00; B62J 99/00; B62M 7/02; F02M 35/024; F02M 35/16

(52) U.S. Cl. CPC B62K 11/04; B62K 25/20; B62K 25/06; B62J 1/08; B62J 25/00; B62K 23/06; B62J 6/005; B62J 99/00; B62M 7/02; F02M 35/024; F02M 35/162; B62J 35/00

(57) ABSTRACT

A motorcycle includes: a front end subassembly including a fork, a suspension support, a shaft, an axle, and a wheel, wherein the suspension support is coupled to the fork, wherein the shaft is rigid, rectilinear, and extends from the suspension support such that the shaft is (1) parallel to the fork and (2) transverse to the axle, wherein the wheel rotates about the axle; and a seat subassembly including a passenger seat, a gas tank, and a passage, wherein the gas tank is positioned between the passenger seat and the passage, wherein the shaft extends through the passage and thereby solely couples the front end subassembly to the seat subassembly such that the front end subassembly is able to steer the seat subassembly.

### CROSS REFERENCE TO RELATED APPLICATIONS

This application claims a benefit of priority to U.S. Provisional Application Ser. No. 62/378,178 filed 22 Aug. 2016; and U.S. Provisional Application Ser. No. 62/378,721 filed 24 Aug. 2016; each of which is incorporated herein by reference in its entirety for all purposes.

### TECHNICAL FIELD

Generally, this disclosure relates to a vehicle with innovative systems and components. In particular, this disclosure relates to constructing a motorcycle with innovative systems and components.

### BACKGROUND

Conventional motorcycles can be difficult to construct or maintain due to a desire for some, most, or all of components thereof being structured or contained in a relatively small volume. Accordingly, there is a need for a motorcycle that can be constructed or maintained using less labor.

### SUMMARY

An embodiment includes a motorcycle comprising: a front end subassembly including a fork, a suspension support, a shaft, an axle, and a wheel, wherein the suspension support is coupled to the fork, wherein the shaft is rigid, rectilinear, and extends from the suspension support such that the shaft is (1) parallel to the fork and (2) transverse to the axle, wherein the wheel rotates about the axle; and a seat subassembly including a passenger seat, a gas tank, and a passage, wherein the gas tank is positioned between the passenger seat and the passage, wherein the shaft extends through the passage and thereby solely couples the front end subassembly to the seat subassembly such that the front end subassembly is able to steer the seat subassembly.

An embodiment includes motorcycle comprising: an actuator; a turn signal configured to be rotated on an axis by the actuator and including a light that can be illuminated; a seat assembly containing an opening configured to receive the turn signal when the turn signal is in a closed position; and a turn signal controller configured to turn on the light and command the actuator to rotate the turn signal to a position outside of the opening.

An embodiment includes a motorcycle comprising: a passenger peg configured to be rotated on an axis to an open position; and a seat assembly containing an opening configured to receive the passenger peg when the passenger peg is in a closed position.

### BRIEF DESCRIPTION OF DRAWINGS

FIG. 1 illustrates an embodiment of a motorcycle according to an exemplary embodiment of this disclosure;

FIG. 2 illustrates exemplary side views of clear cam covers in an embodiment of this disclosure;

FIG. 3 illustrates front and back end view of the motorcycle shown in FIG. 1;

FIGS. 4 and 5 illustrate the assembly of the motorcycle subassemblies shown in FIG. 1;

FIGS. 6 and 7 illustrate and describe an exemplary handle bar of this disclosure;

FIG. 8 shows a front view of an exemplary front assembly of this disclosure;

FIGS. 9 and 10 show an exemplary connection of the front subassembly and the seat subassembly of this disclosure;

FIG. 11 shows views of an exemplary front suspension support of this disclosure;

FIG. 12 shows a top view of exemplary front and rear lights of this disclosure;

FIG. 13 shows views of the front and rear lights shown in FIG. 12;

FIG. 14 shows views of the front and rear lights and the rear view camera;

FIG. 15 shows views of an exemplary display of this disclosure;

FIG. 16 shows views of an exemplary passenger peg of this disclosure;

FIG. 17 shows views of an exemplary passenger seat structural support of this disclosure;

FIG. 18 shows views of an exemplary rotating gas tank of this disclosure;

FIG. 19 shows views of exemplary heat shields of this disclosure;

FIGS. 20 and 20A show views of exemplary heat dissipation devices of this disclosure;

FIG. 21 shows an external view of an exemplary engine case of this disclosure;

FIGS. 22 and 23 show views of exemplary exhaust passages of this disclosure;

FIGS. 24 and 25 show views of an exemplary kickstand of this disclosure;

FIGS. 26 and 29 shows views of an exemplary foot control subassembly of this disclosure;

FIGS. 27 and 28 show views of exemplary oil passages of this disclosure;

FIG. 30 shows views of an exemplary transmission assembly of this disclosure;

FIG. 31 shows views of an exemplary gearing system of this disclosure;

FIG. 32 shows views of installing the transmission system shown in FIG. 30;

FIG. 33 shows views of an exemplary structural bridge of this disclosure;

FIG. 34 shows the rear wheel assembly;

FIG. 36 shows views of form finishing washers of this disclosure;

FIGS. 37-39 shows views of an exemplary rear wheel assembly of this disclosure; and

FIG. 40 shows views of the structural bridge shown in FIG. 33.

### DETAILED DESCRIPTION

Reference is presently made in detail to exemplary embodiments of this disclosure, one or more examples of which are illustrated in or represented by the drawings. Each example is provided by way of explanation of this disclosure, not limitation of this disclosure. In fact, it will be apparent to skilled artisans that various modifications and variations can be made in this disclosure, without departing from a scope or spirit of this disclosure. For instance, features illustrated or described as part of one embodiment can be used with another embodiment to yield a still further embodiment. Thus, it is intended that this disclosure covers such modifications and variations as come within the scope of the disclosure and equivalents thereof.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

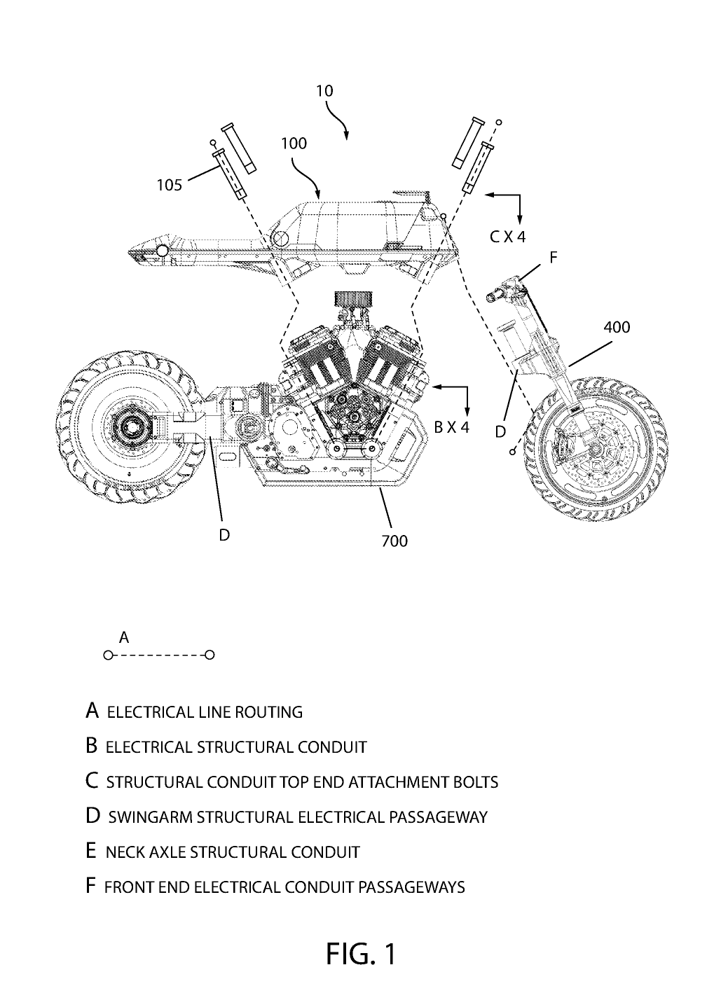

FIG. 1 shows a motorcycle 10 according to one embodiment of this disclosure. As shown in FIGS. 1 and 4, the motorcycle 10 includes a seat subassembly 100, a front end subassembly 400, and an engine and drive train subassembly 700. The seat subassembly 100 is attached to the engine and drive train subassembly 700 using only 4 bolts 105. Thus, the seat subassembly 100 can be disconnected from the engine and drive train subassembly 700 quickly and easily. In contrast to conventional motorcycles which include a main frame that all of the components are connected to, the motorcycle 10 does not include any main frame. The subassemblies 100, 400, and 700 are directly connected to each other, which eliminates the need for a main frame. Thus, cost, weight, and labor of using a main frame are eliminated from the motorcycle 10.

FIG. 1 also shows structural conduits for running the electrical wires throughout the motorcycle 10. The front end subassembly 400 includes conduits E and F which supply power to the headlights and carry commands from the handlebar controls. Note that the front end subassembly 400 includes a motorcycle work.

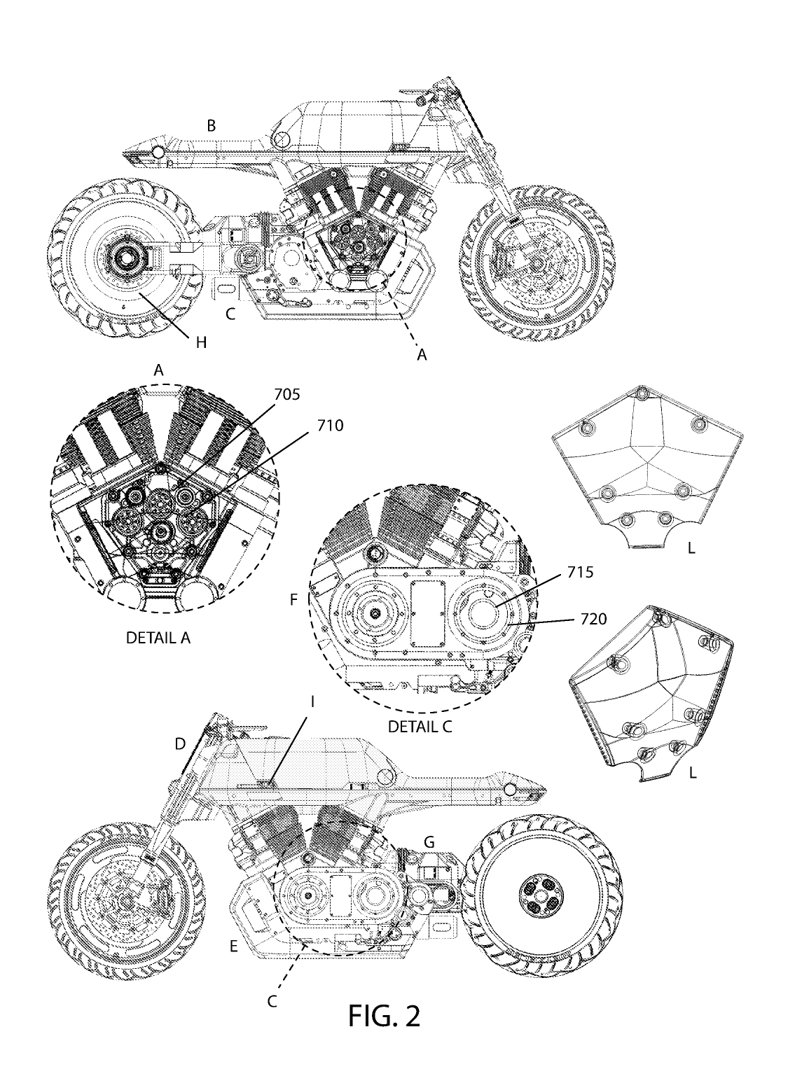

FIG. 2 shows the sides of engine and drive train subassembly 700. On one side of the motorcycle 10, a clear cam chest 705 allows a view of a plurality of cams 710 beneath. On opposing side of the motorcycle 10, a clear case 715 allows a view of a clutch drive 720.

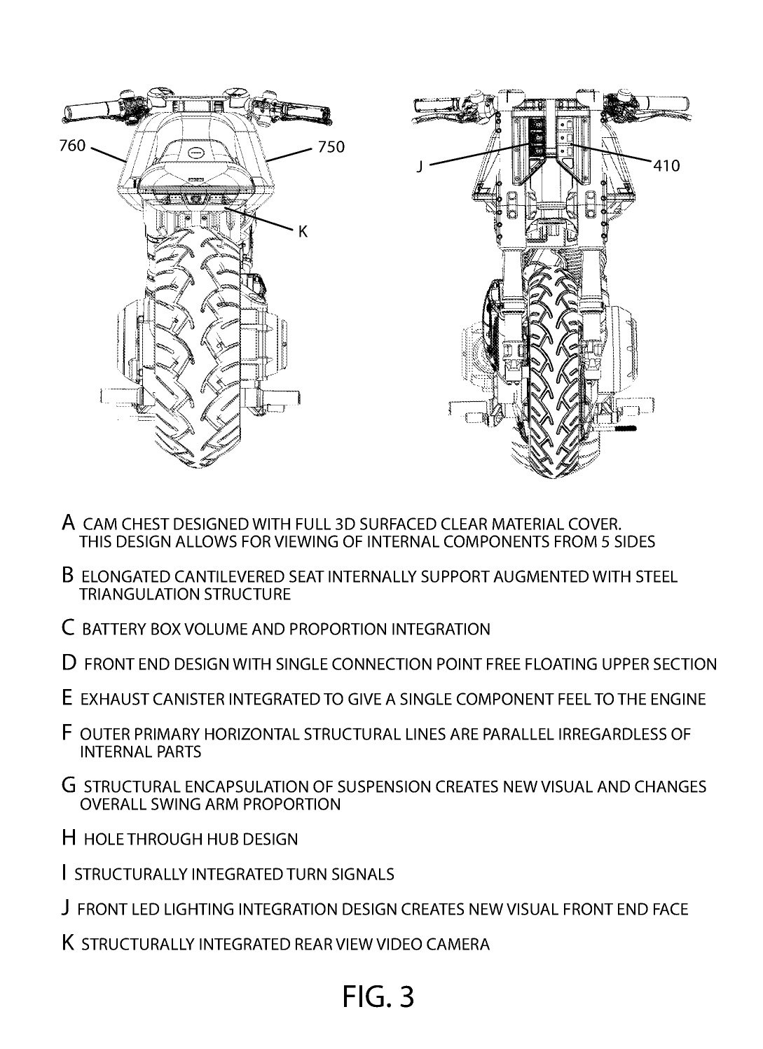

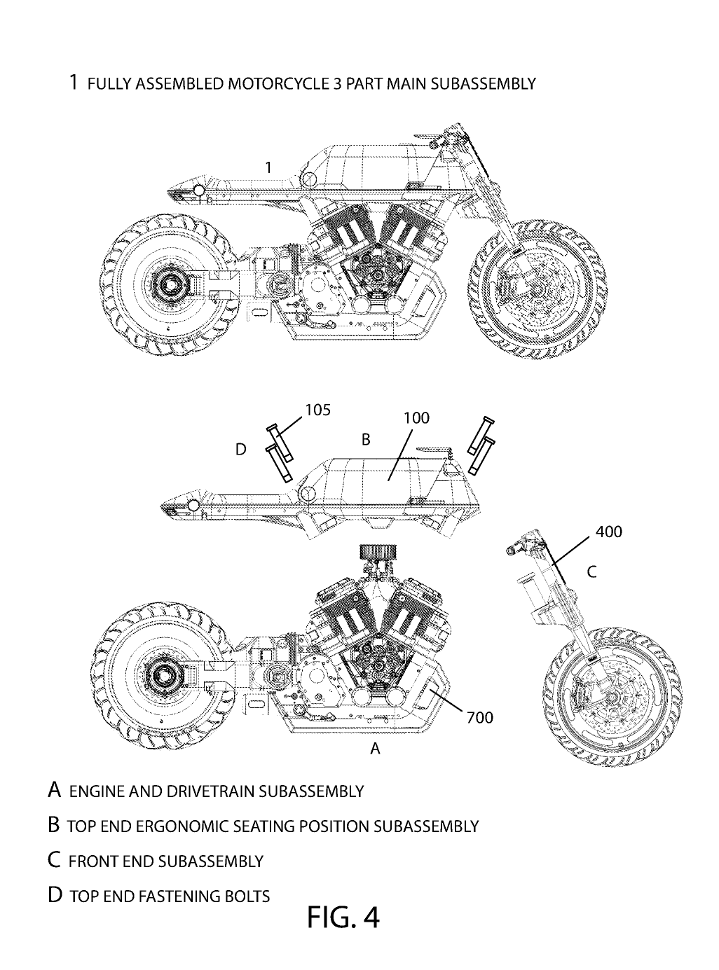

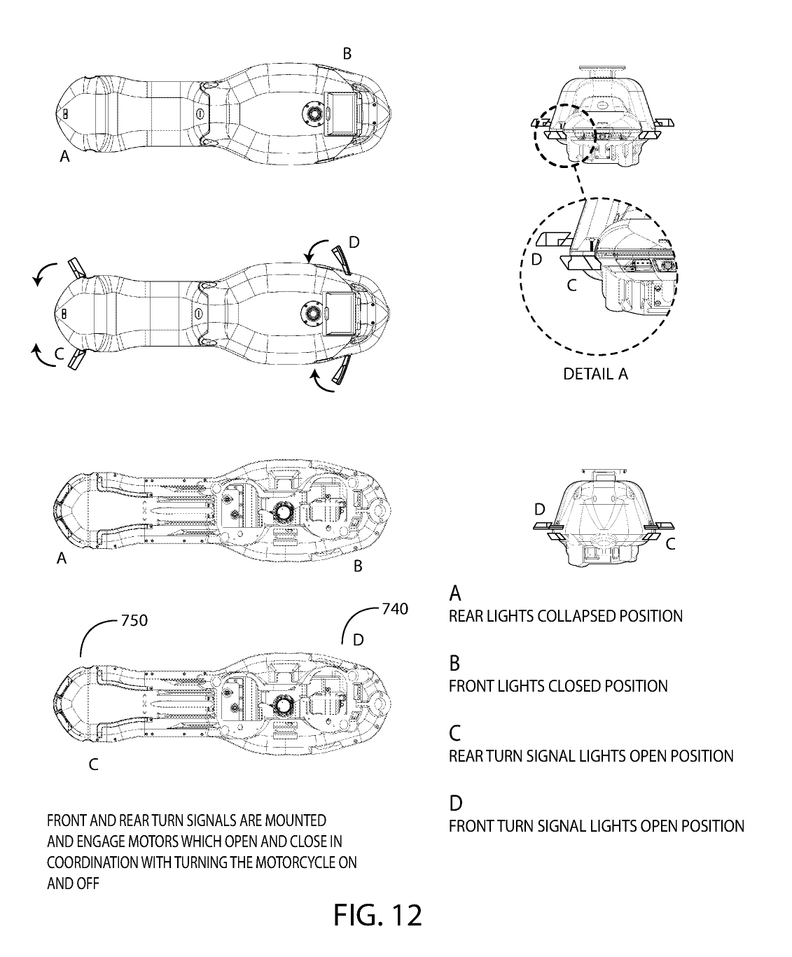

FIG. 3 shows front and back end views of the motorcycle 10. The front view shows a set of light emitting diode (LED) headlights 410. The rear view shows a set of turn signals 750 in their off position (turn signals 750 rotate out of the subassembly 700 when activated, as shown in FIG. 12.) A rear view camera 760 is integrated into a center rear of the subassembly 700.

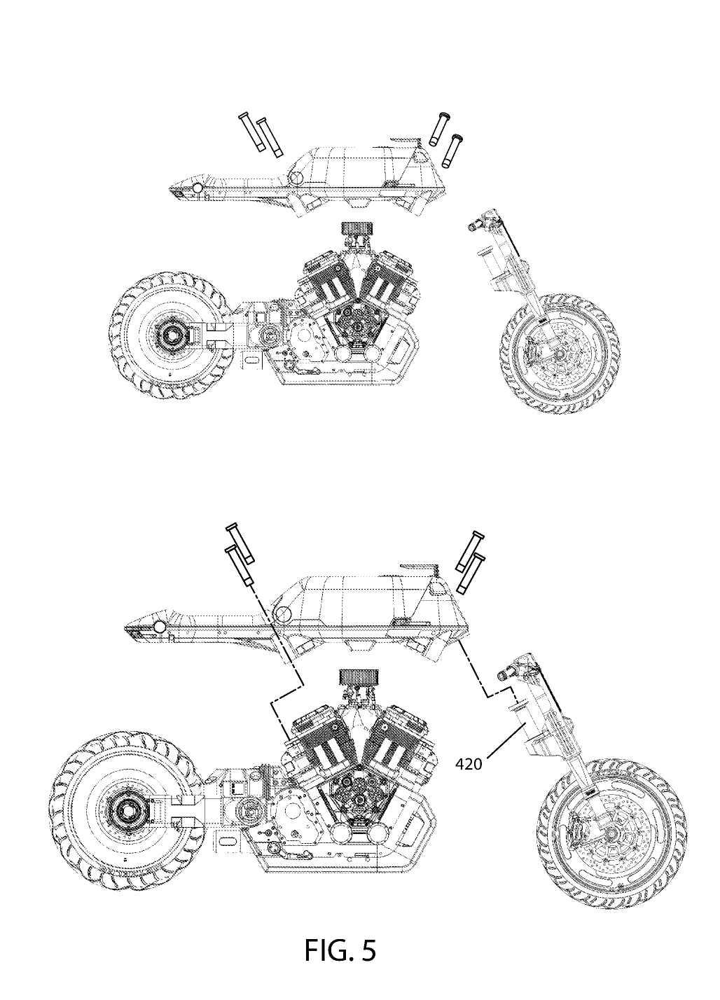

FIG. 5 shows that front end assembly 400 includes a shaft 420 that is rigid and connects to the subassembly 100, with the motorcycle fork supporting the shaft 420 and the shaft 420 extending from the motorcycle fork such that the shaft 420 is non-perpendicular to a ground surface on which a front wheel rests. Thus, the front end assembly 400 is not directly connected to subassembly 700, allowing for quicker and easier assembly and disassembly. Note that the shaft 420 can be internally hollow or filled. The shaft 420 is tubular and can be solid or perforated.

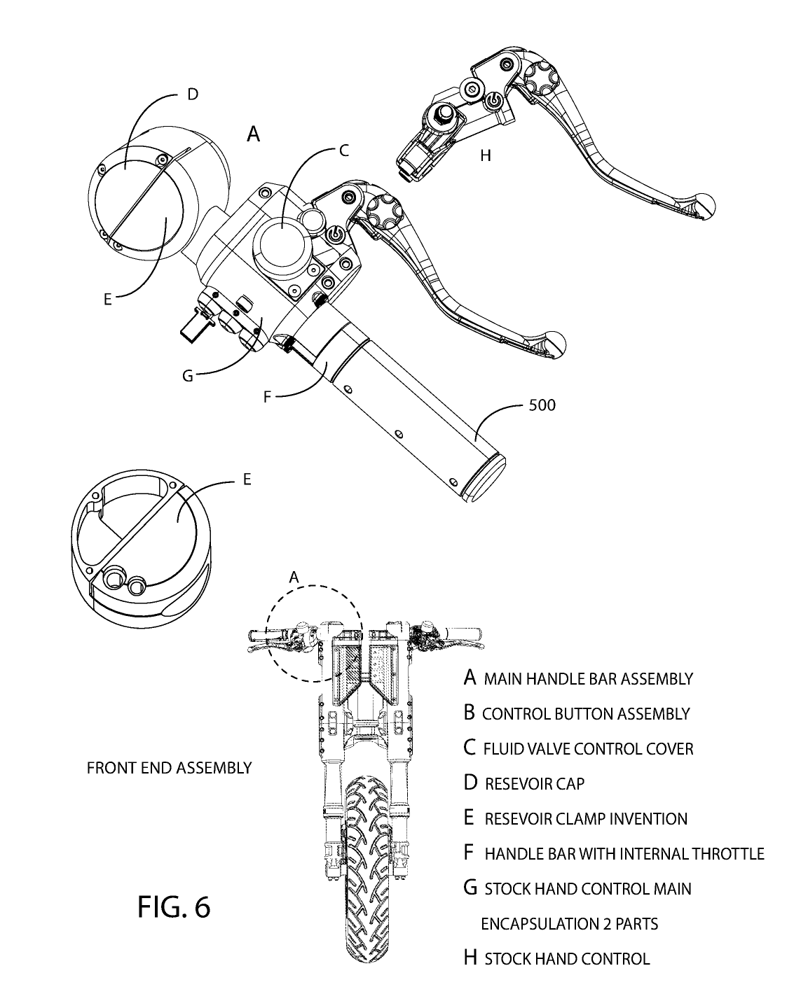

FIG. 6 shows a main handlebar assembly 500, which is connected to the front end assembly 400. The assembly 500 includes control buttons B, a fluid valve control cover C, a reservoir cap D, a handlebar with an internal throttle F, and a hand control G and H. The hand control G and H send commands to a braking system. The throttle F sends commands to the engine. Control buttons B may be for any other controls needed, such as turn signals and the starter.

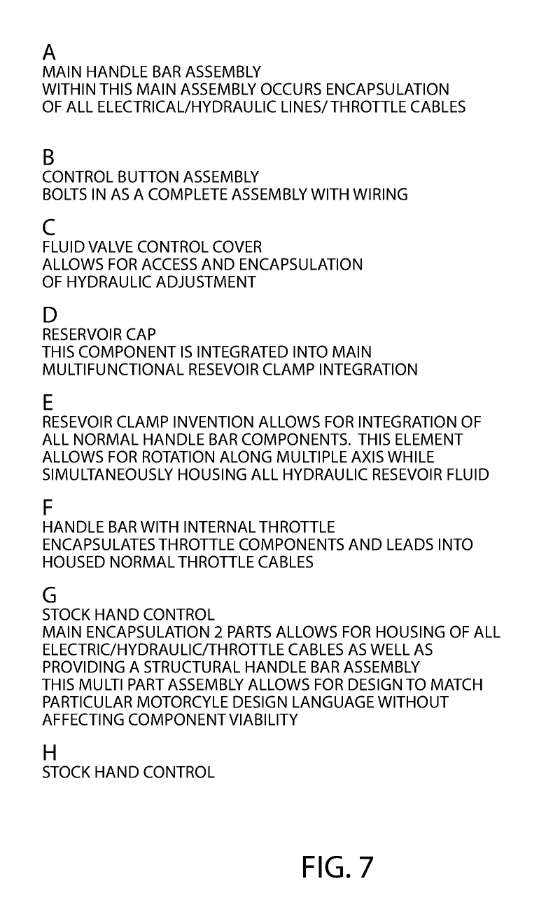

FIG. 7 describes various features of the assembly 500.

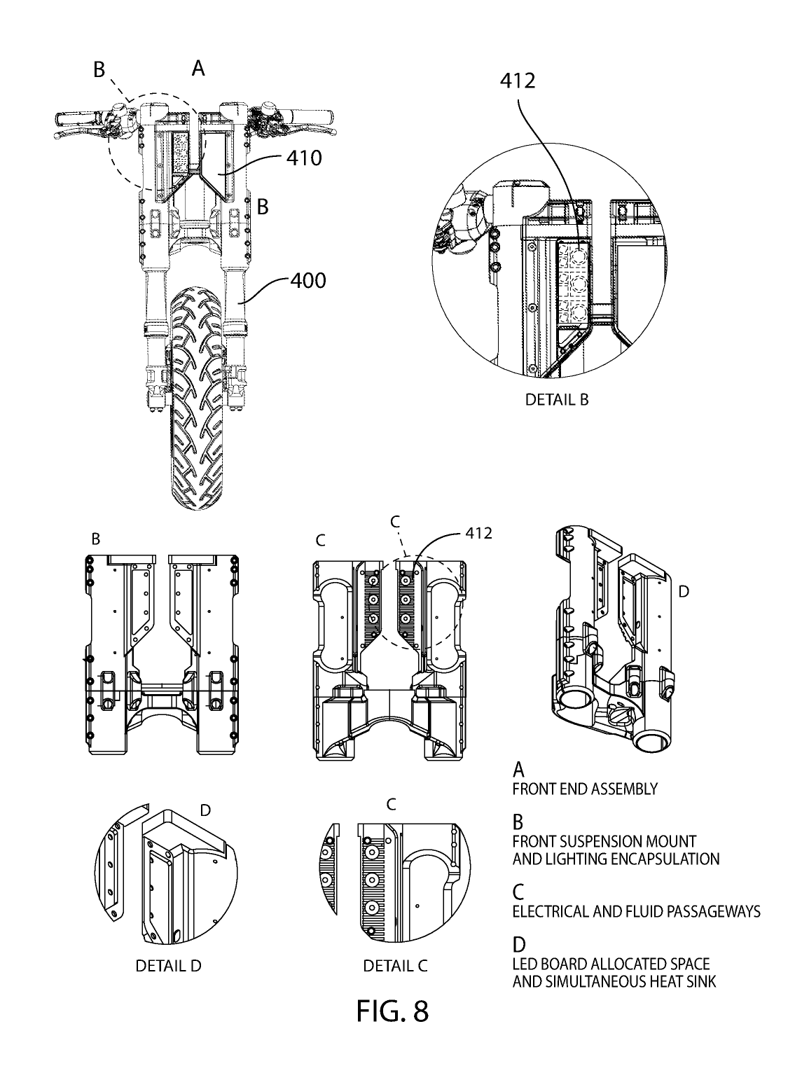

FIG. 8 shows various details of the LED headlight assembly 410. The LED headlight assembly 410 includes multiple LEDs 412, for example, six. Other numbers of LEDs are within the scope of the invention as claimed.

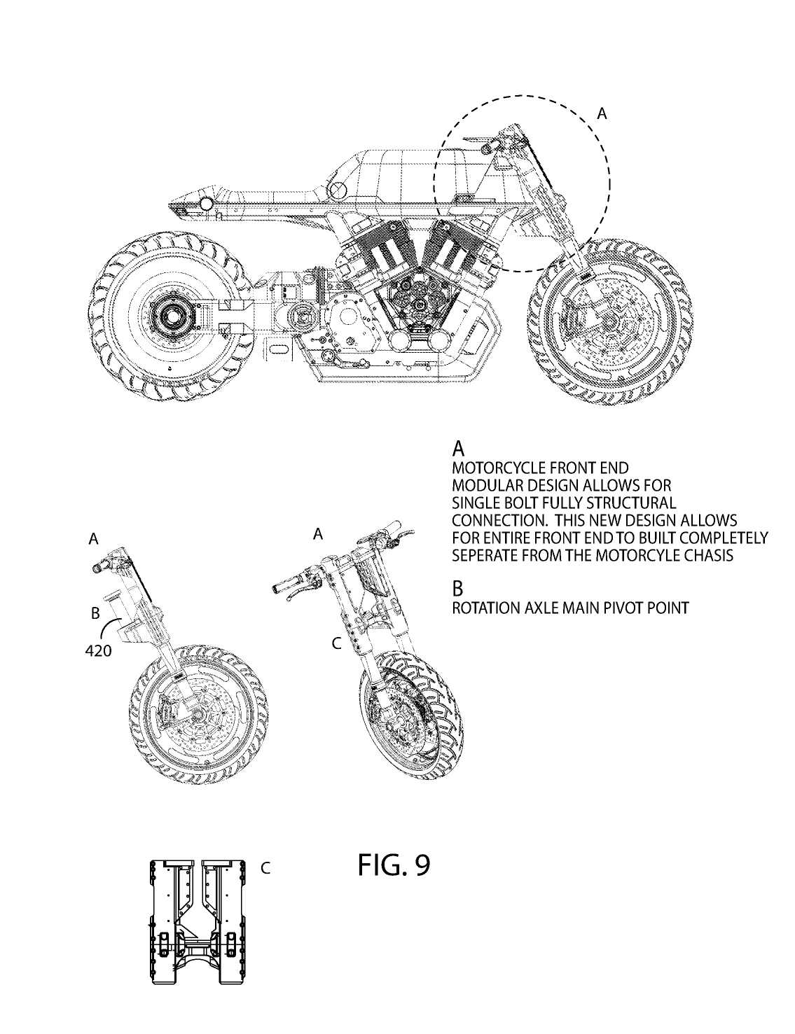

FIG. 9 shows that the front end subassembly 400 is connected to the subassembly 100 by only shaft 420. This allows the subassembly 400 to be completely constructed separate from the rest of the motorcycle 10 and then connected to be fully complete. This allows for more efficient manufacturing, as well as more efficient maintenance and repair.

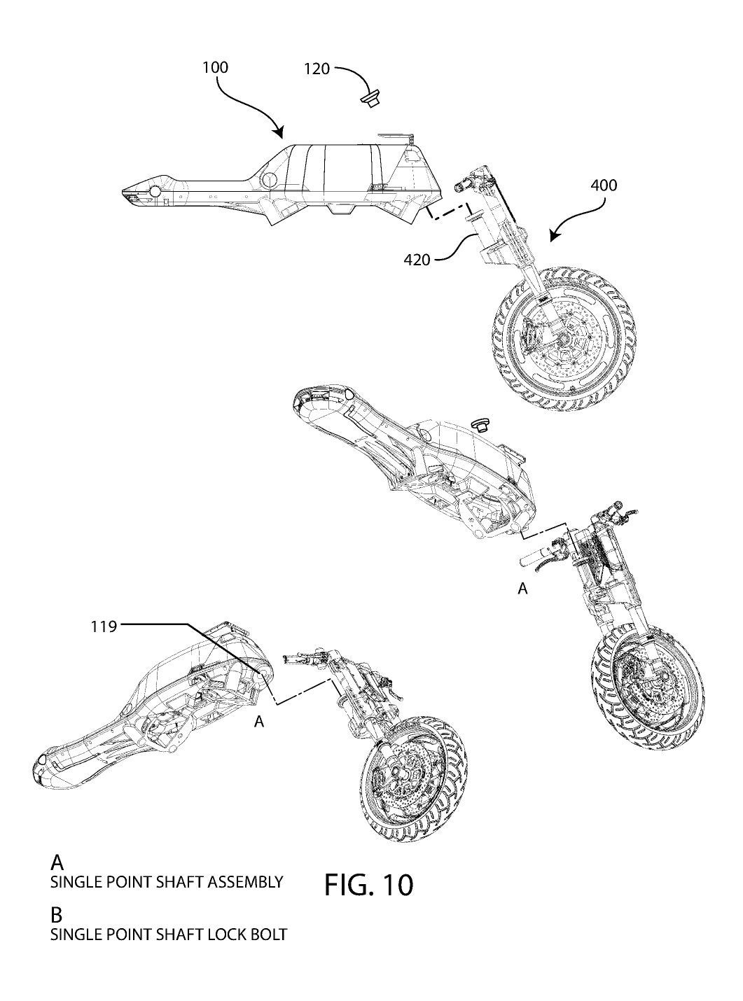

FIG. 10 shows that the subassembly 100 includes an opening 119 that receives the shaft 420 of the subassembly 400. A lock bolt 120 then is attached to the shaft 420 to quickly and easily secure the subassembly 400 to the subassembly 100.

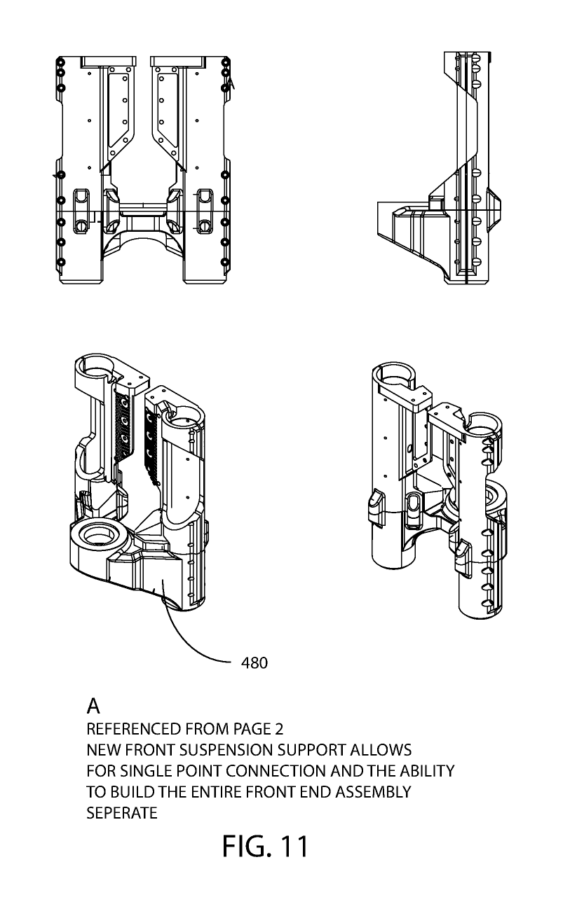

FIG. 11 shows a front suspension support 480, which allows for a single point connection to the subassembly 100. One or more wires from the subassembly 100 run through the support 480 to the subassembly 400 to, for example, provide power to the LED headlights 410. As shown, the front suspension support 480 includes a pair of tubular portions coupled to each other a via third tubular portion that is positioned between the pair of tubular portion and secured to the pair of tubular portions via pair of corresponding brackets, which can include metal, alloys, or other materials.

FIG. 12 shows that the front lights 740 and the rear lights 750 can be located along a range of positions. When the motorcycle 10 is off, the front lights 740 and the rear lights 750 are located within apertures in the subassembly 100 such that an outer surface of the front lights 740 and the rear lights 750 is substantially flush with the outer surface of the subassembly 100. When the motorcycle 10 is turned on, the front lights 740 and the rear lights 750 rotate out to extend from the subassembly 100 at positions C and D, as shown in FIG. 12. The front lights 740 and the rear lights 750 may be illuminated at this time. After a period of time, the front lights 740 or the rear lights 750 lights may be turned off. The front lights 740 and the rear lights 750 may also be illuminated when a driver signals a turn, which may be via the main handlebar assembly 500. In a similar manner, when a warning light is activated by the driver, such as via the main handlebar assembly 500, some, most, or all of the front lights 740 or the rear lights 750 may be illuminated. When the motorcycle 10 is turned off, some, most, or all of the front lights 740 and the rear lights 750 may be rotated back into the subassembly 100 such that the front lights 740 and the rear lights 750 are substantially flush with the outer surface of the subassembly 100.

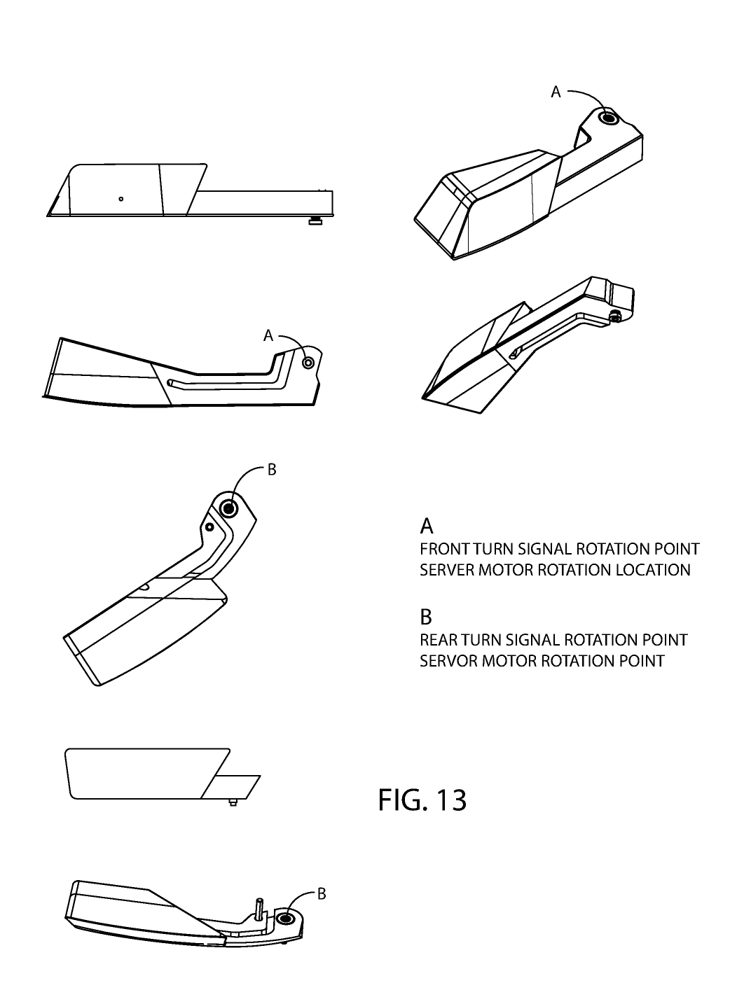

FIG. 13 shows various details of a location of a servo that drives the front lights 740 and the rear lights 750 into and out of the subassembly 100.

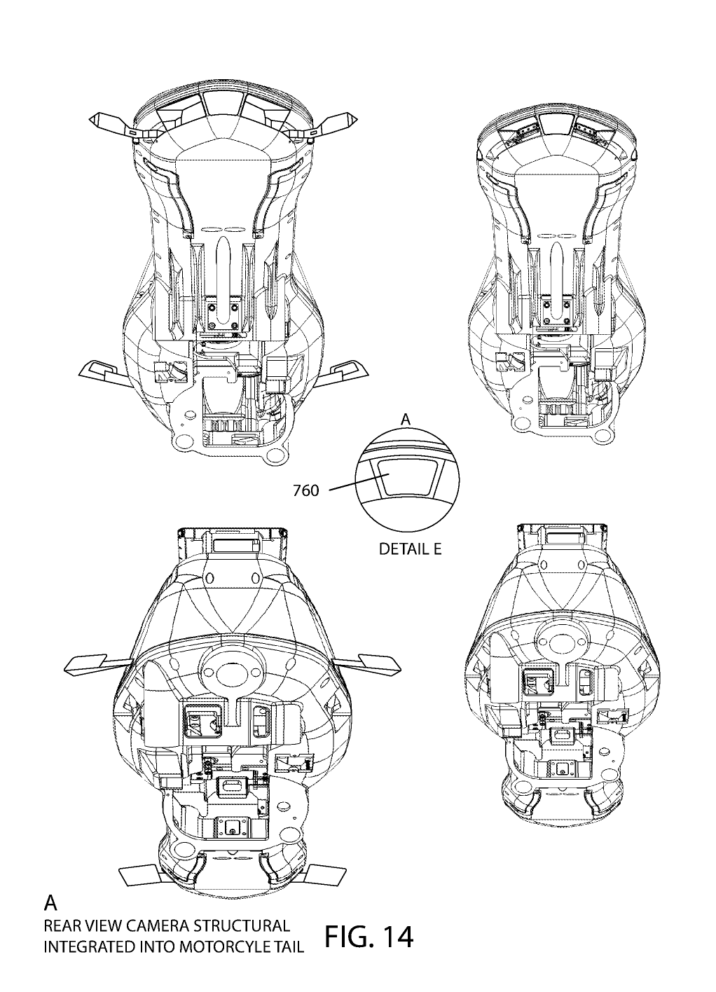

FIG. 14 shows the front lights 740 and the rear lights 750 both extended and recessed, as well as the rear view camera 760.

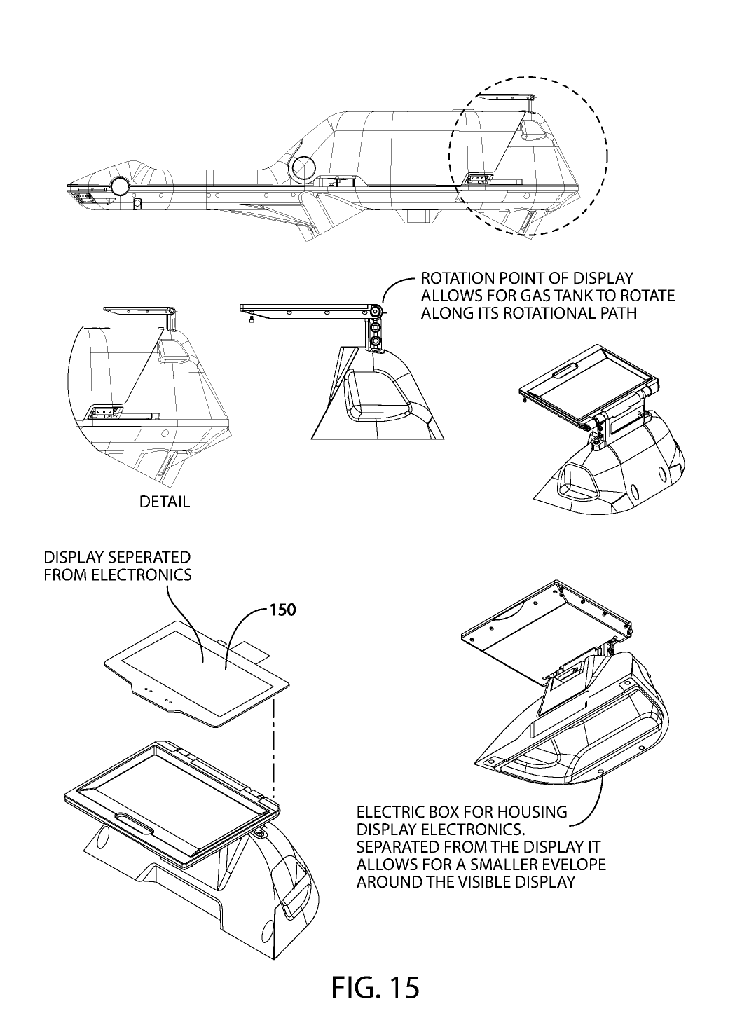

FIG. 15 shows a display 150 that is mounted on a top front of the subassembly 100 such that the display 150 is easily viewable and accessible to the driver when driving. The display 150 is used to display, among other things, a still image or a video captured by the rear view camera 760. The display 150 may also display other information, such as current speed, fuel remaining, a map, infotainment icons, or others. Other display functions are within the scope of this disclosure.

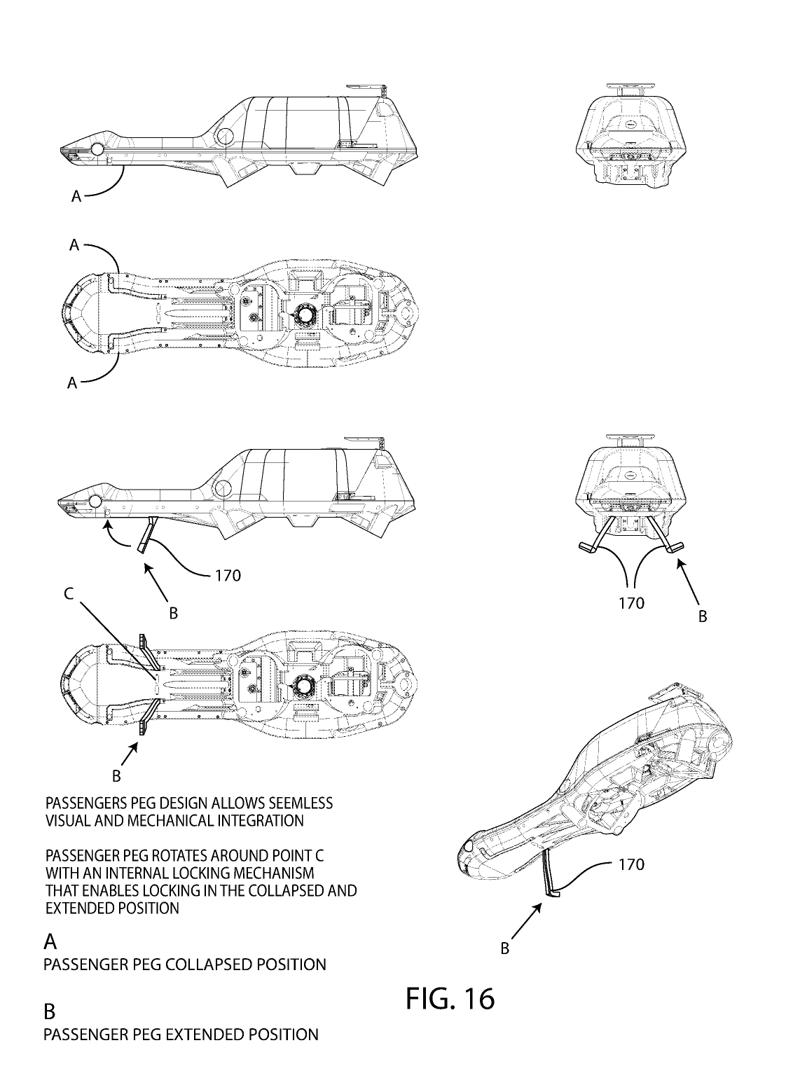

FIG. 16 shows a passenger peg 170 in both extended and collapsed positions. The passenger peg 170 is extended when a passenger is going to ride behind the driver. The passenger peg 170 is a safe place for the passenger to put their feet while riding. As shown in FIG. 16, in the collapsed position, an outer surface of the passenger peg 170 is substantially flush with the outer surface of the subassembly 100.

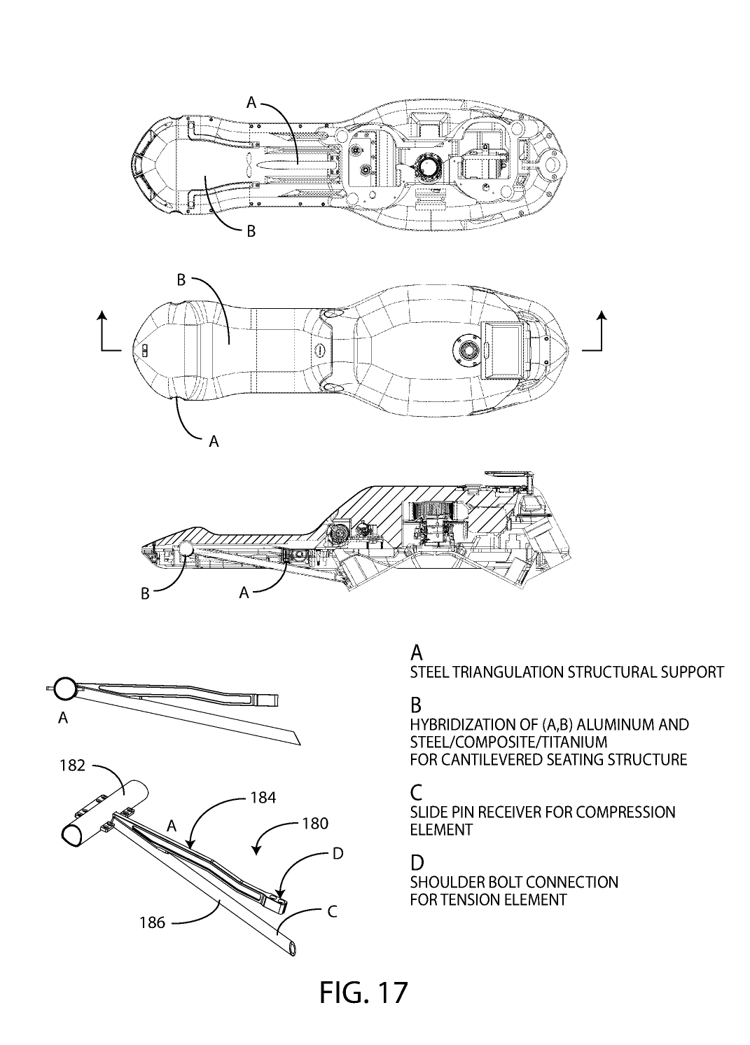

FIG. 17 shows a three part steel structural support 180 that is located within a passenger seat portion of the subassembly 100. As the passenger seat extends a substantial distance over a rear tire, the support 180 is included within the passenger seat to provide for extra support. The support 180 includes a steel cylinder 182 that may laterally extend from one side of the passenger seat to the other. The cylinder 182 may or may not have closed ends. The cylinder 182 is connected to an upper support arm 184 and a lower support arm 186. The upper support arm 184 and the lower support arm 186 are connected within the subassembly 100 closer to a connection point to the subassembly 700.

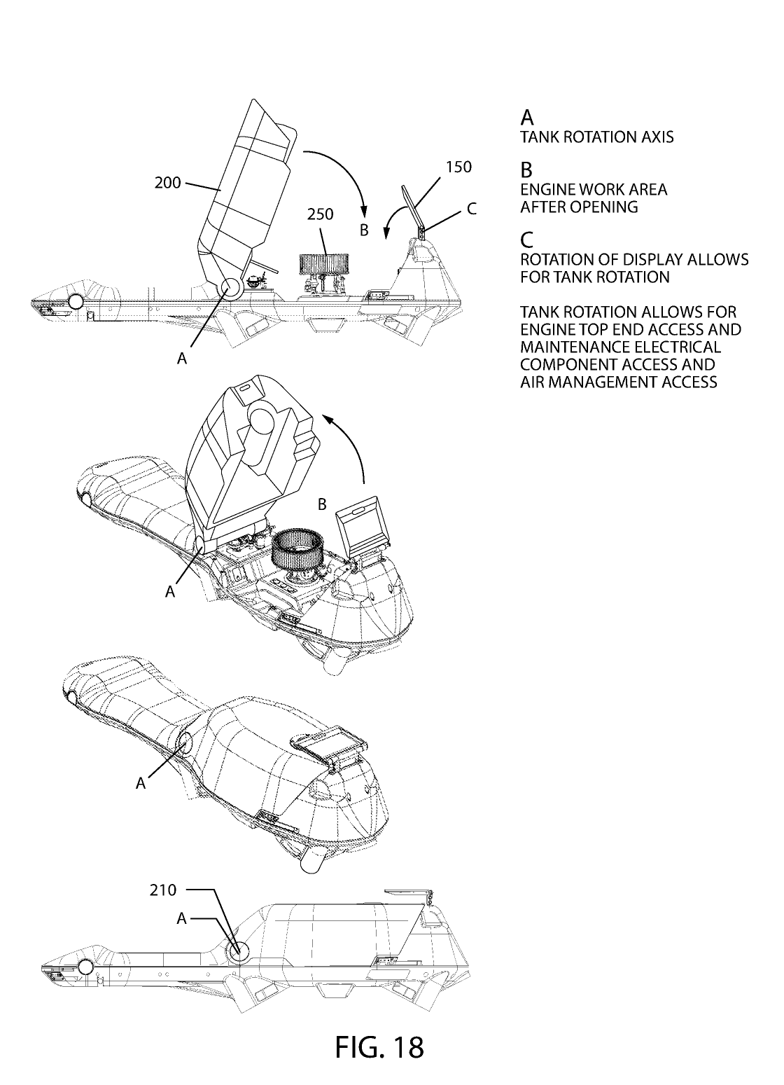

FIG. 18 shows a rotation of a gas tank 200 around an axis 210, which extends lateral to the motorcycle 10. Initially, the display 150 may need to be rotated out in order to minimize interference. Then, the gas tank 200 can be rotated up to reveal an engine work area 250. The area 250 provides access to engine parts and electronics, such as an illustrated air filter. This configuration allows for easier maintenance than conventional motorcycles, and also allows for controlled air flow to the air filter.

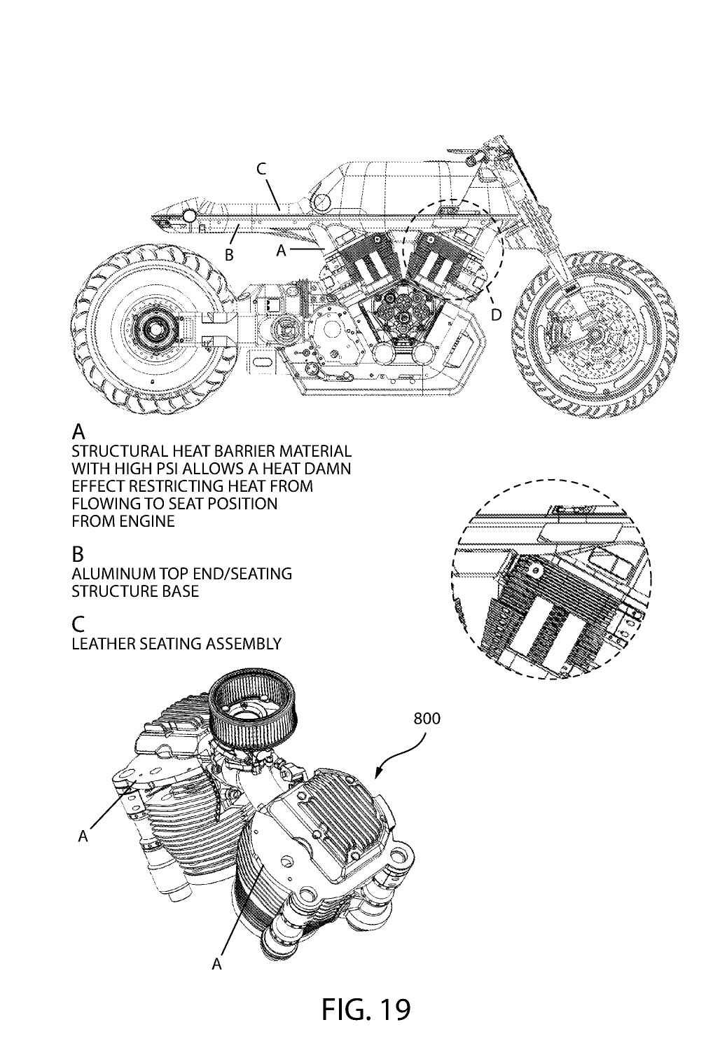

FIG. 19 shows an engine 800 which is part of the subassembly 700. On top of the engine 800 is a heat barrier 810, which is located between the engine 800 and the seat assembly 100. The heat barrier 810 includes a heat insulating material, such as Fabreeka®, sold by Fabreeka International, Inc. However, note that other suitable materials may be used, as known to skilled artisans. The heat barrier 810 effectively prevents engine heat from warming the subassembly 100.

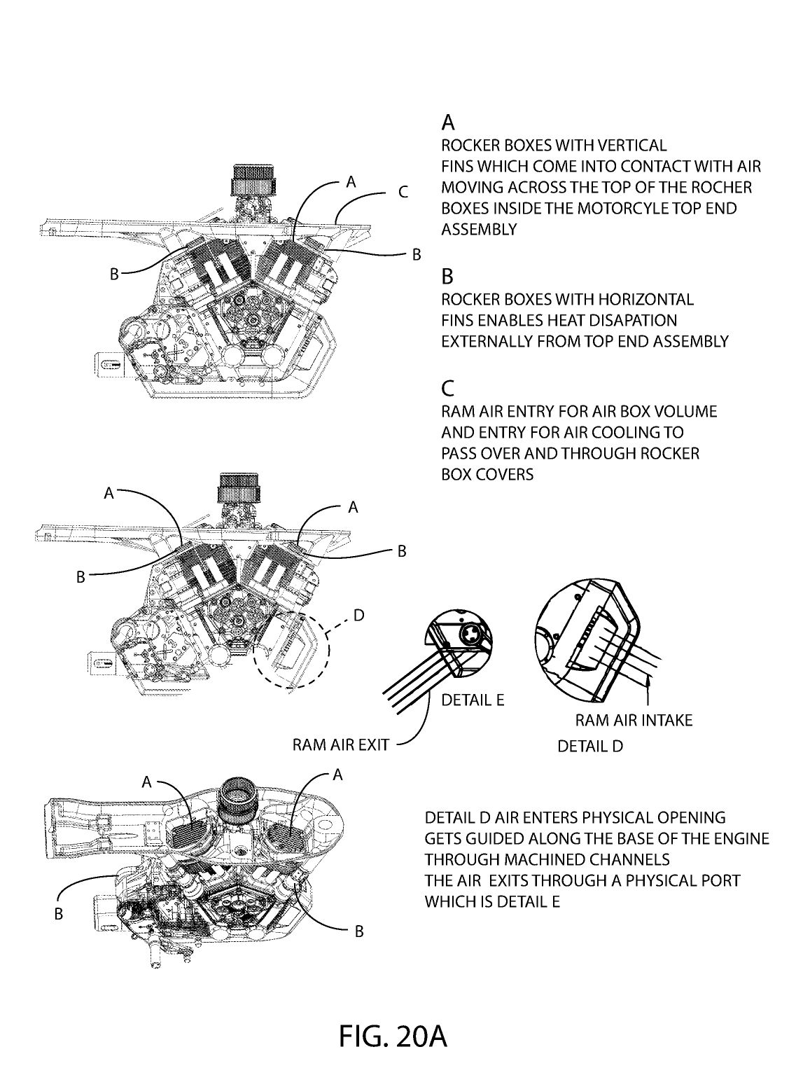

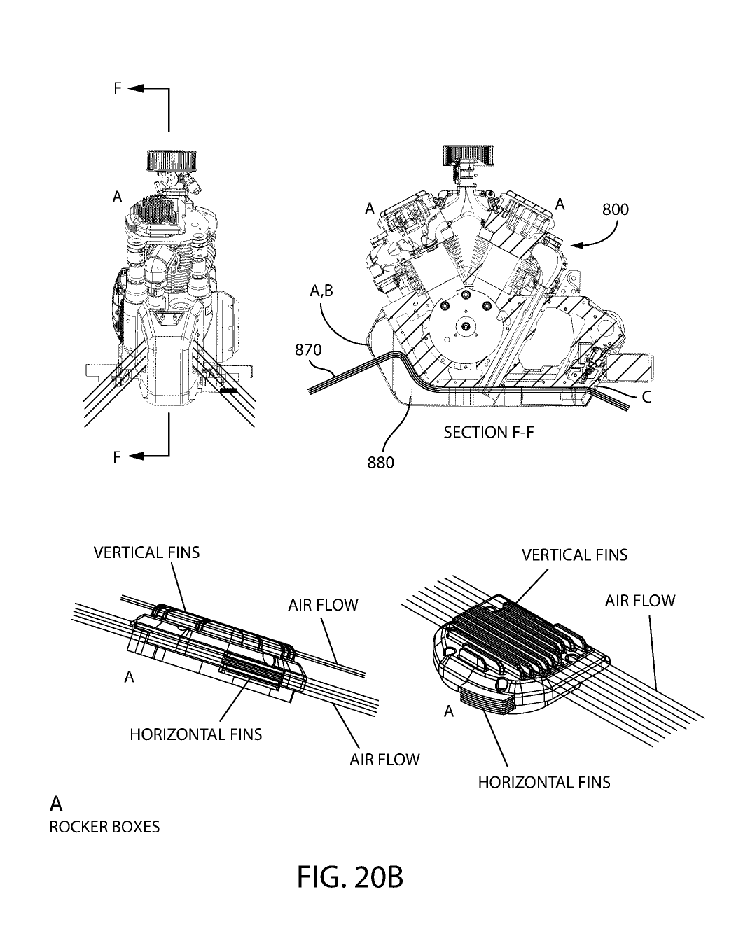

FIG. 20 shows a plurality of heat dissipation devices of the motorcycle 10. A set of rocker boxes are located within the subassembly 700 and have a set of vertical fins A which extend into the subassembly 100 and dissipate heat when air within the subassembly 100 passes over them. The air enters the subassembly 100 through a ram air entry C. The set of rocker boxes also include a set of horizontal fins B which dissipate heat when external air passes over them.

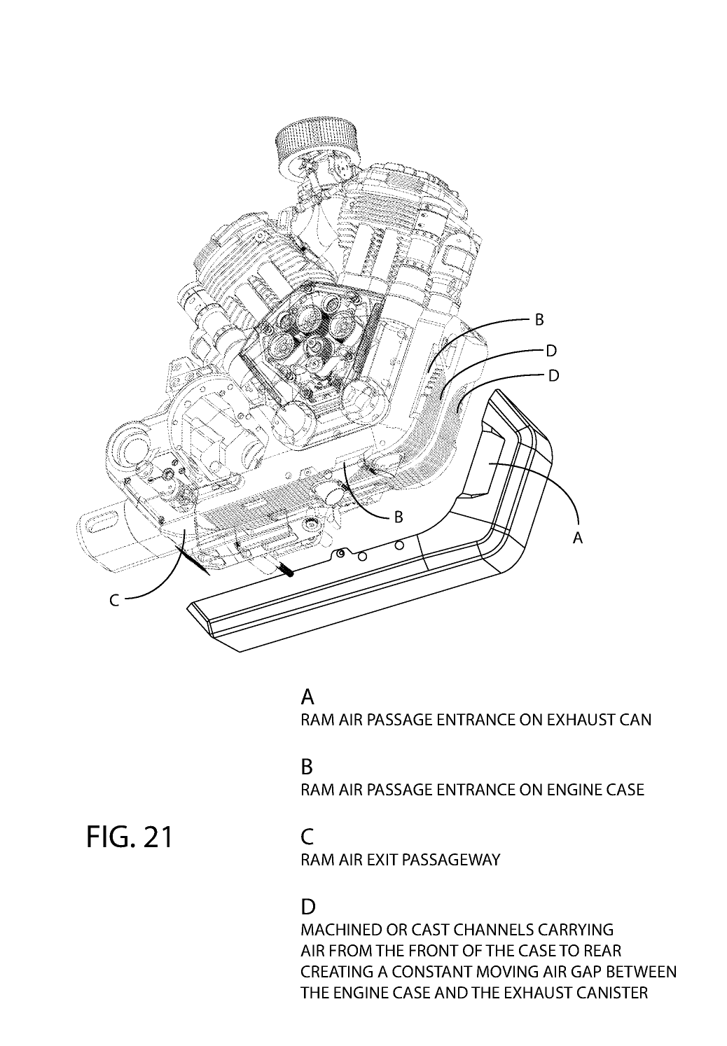

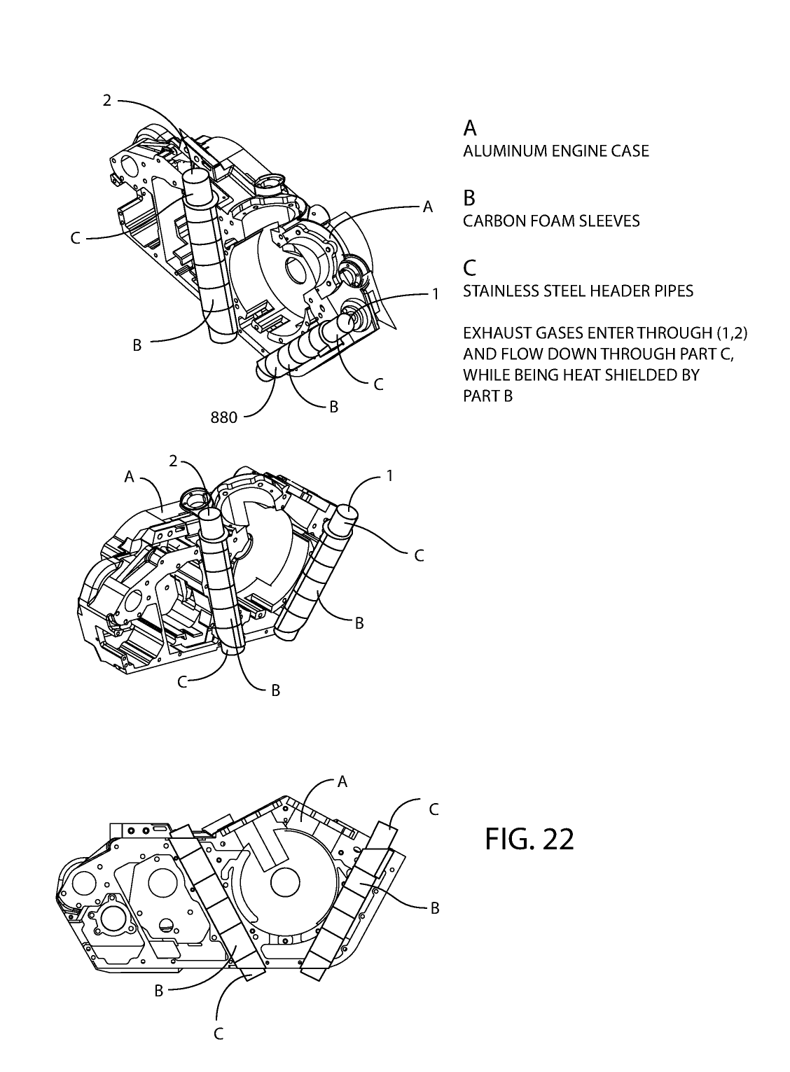

FIG. 20A shows close up views of the rocker boxes A, with vertical fins and horizontal fins. FIGS. 21 and 22 depict the subassembly 700. In particular, an external view of an engine case 850 is presented. The engine case 850 includes an exhaust passageway 880. To prevent heat from being transferred between an exhaust and an engine 800, a ram air passageway 860 runs between the exhaust passageway 880 and the engine 800. The ram air passageway 860 includes a set of air entrances A and B, and an air exit C. FIG. 20A shows an air flow 870 that runs through the air passageway 860 from the set of air entrances A and B to the exit C between the engine 800 and the exhaust passageway 880.

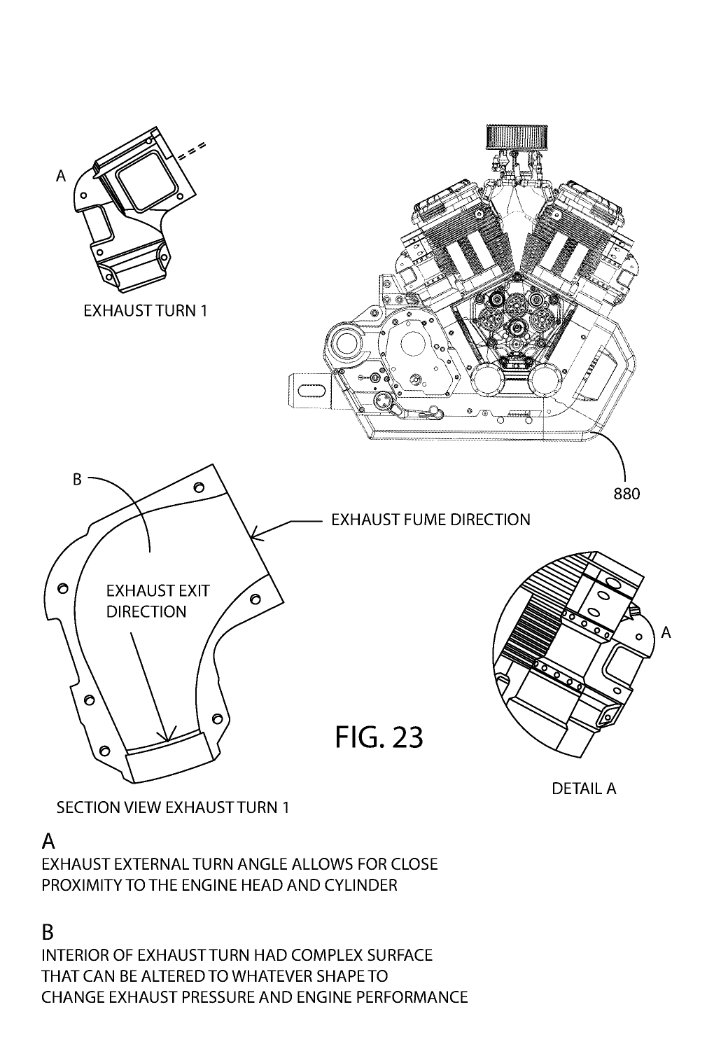

FIG. 22 illustrates that the engine 800 includes at least two pistons, each with a separate exhaust passageway 880 that runs through a steel header pipe C. A carbon foam sleeve B may be located within the exhaust passageway 880 to prevent heat from the exhaust from transferring to the engine 800. As shown in FIG. 23, a top portion of each exhaust passage is connected to the engine 800 by exhaust turn A. As further shown, an internal configuration of each exhaust turn A may be designed to provide optimal performance by changing an exhaust pressure.

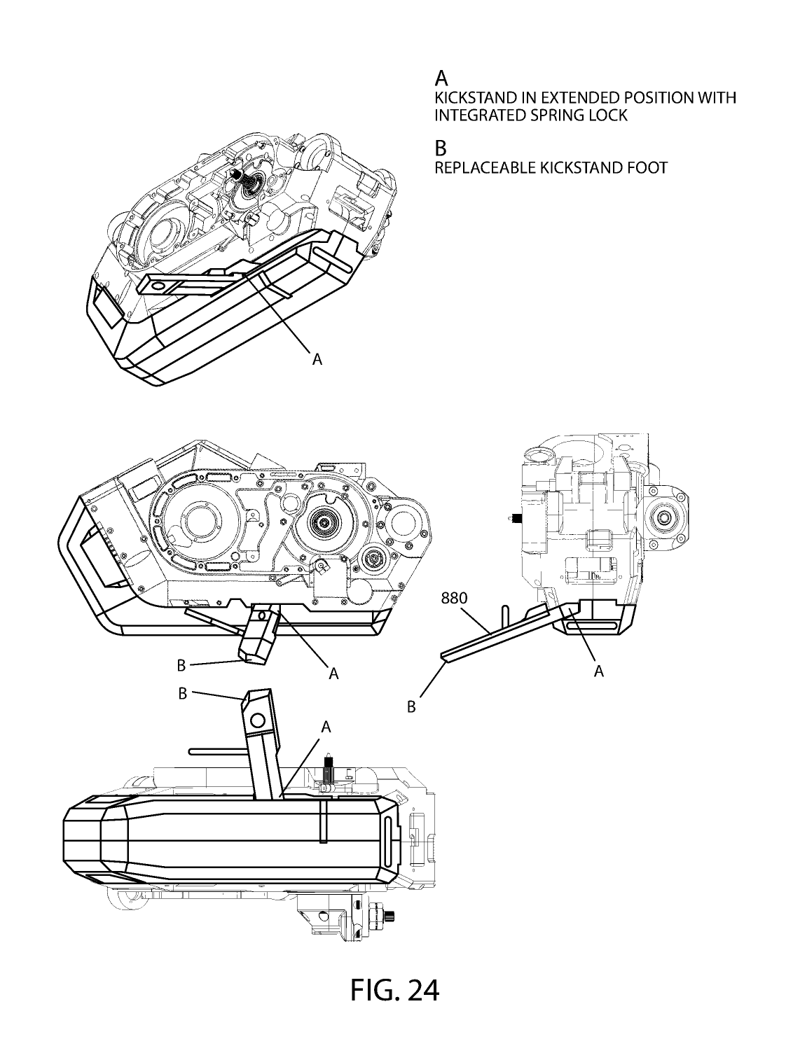

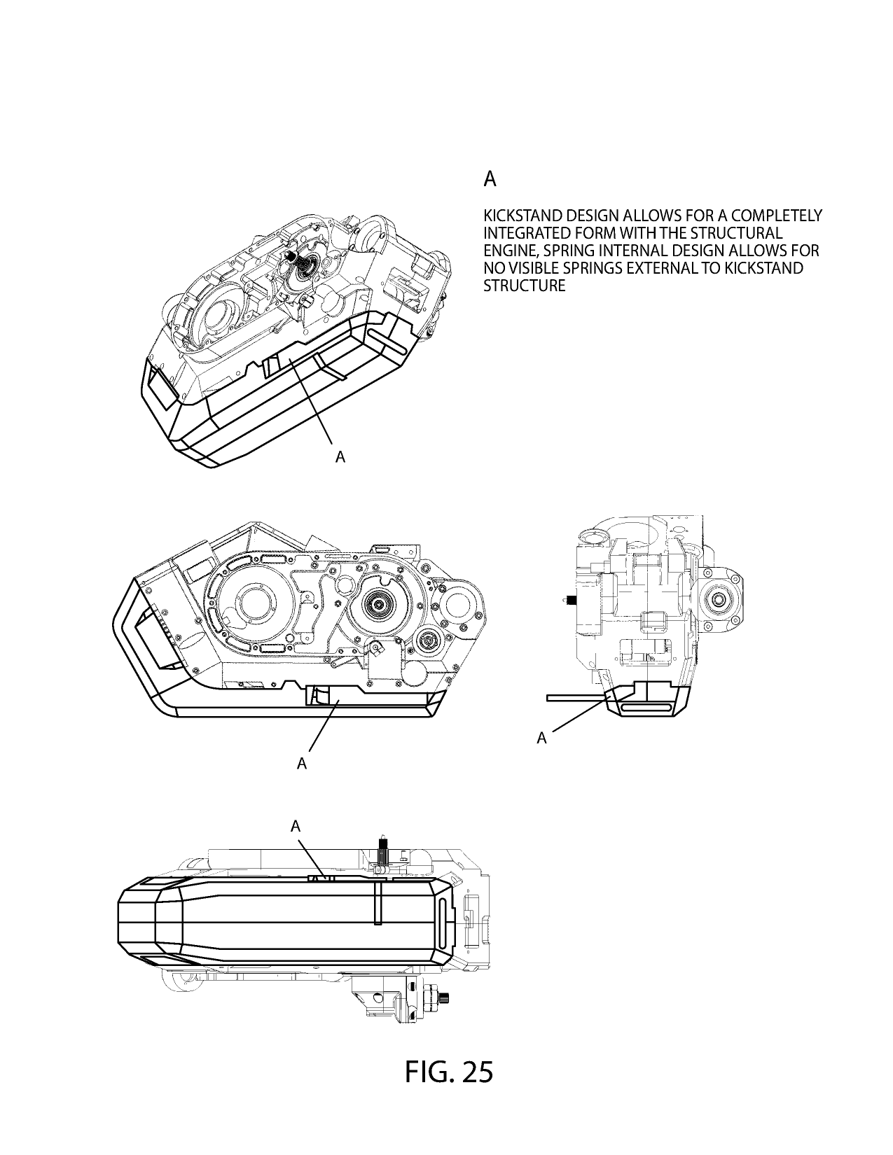

FIGS. 24 and 25 show a kickstand 885 in both collapsed and extended positions. When collapsed, an outer surface of the kickstand 885 is substantially flush with the outer surface of subassembly 700.

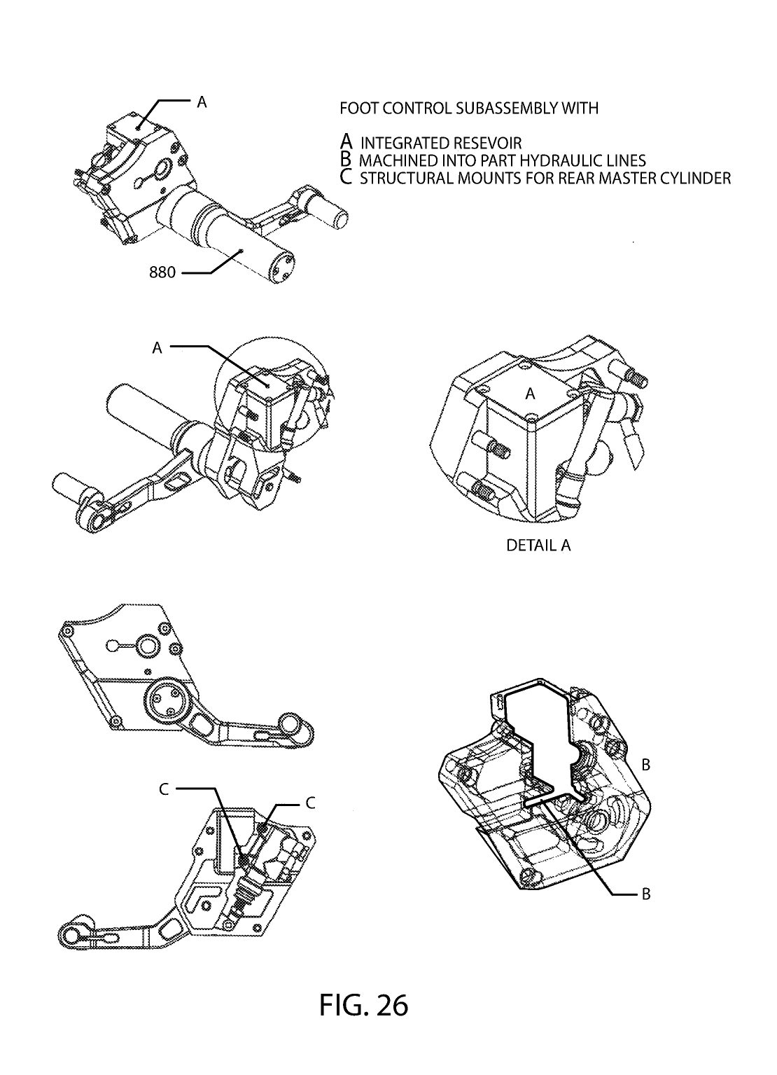

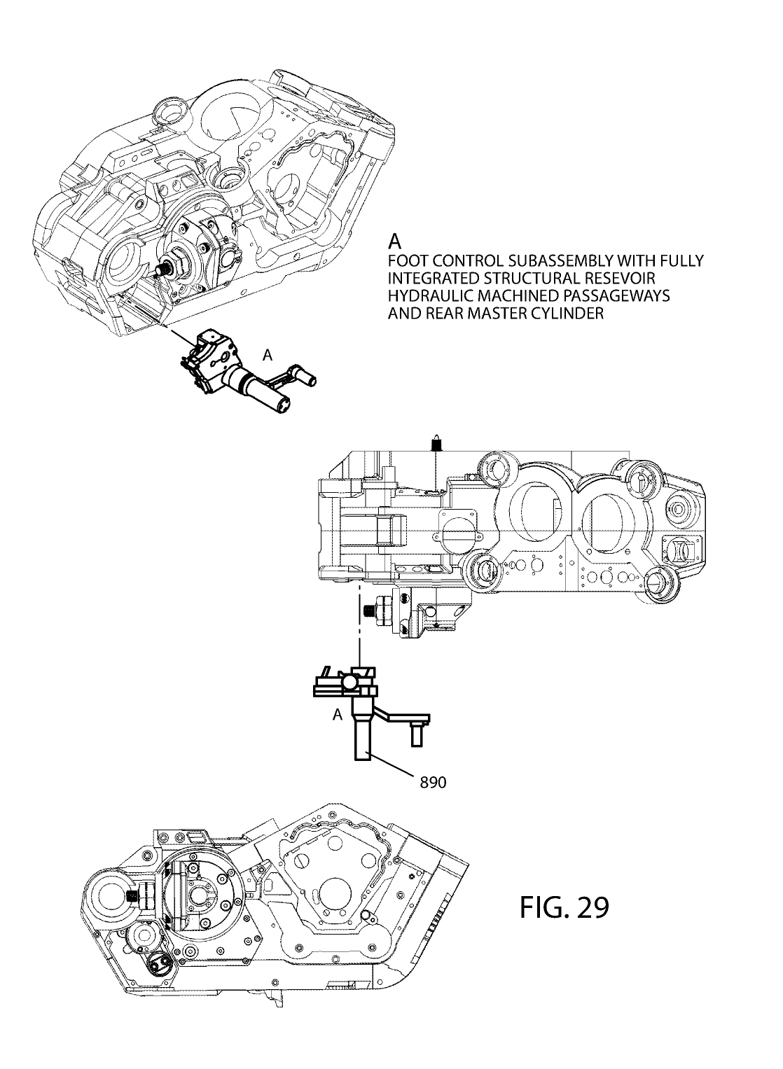

FIGS. 26 and 29 show a foot control assembly 890. The assembly 890 receives commands from the driver's foot and communicates them to a rear brake. The assembly 890 is contained in an engine block.

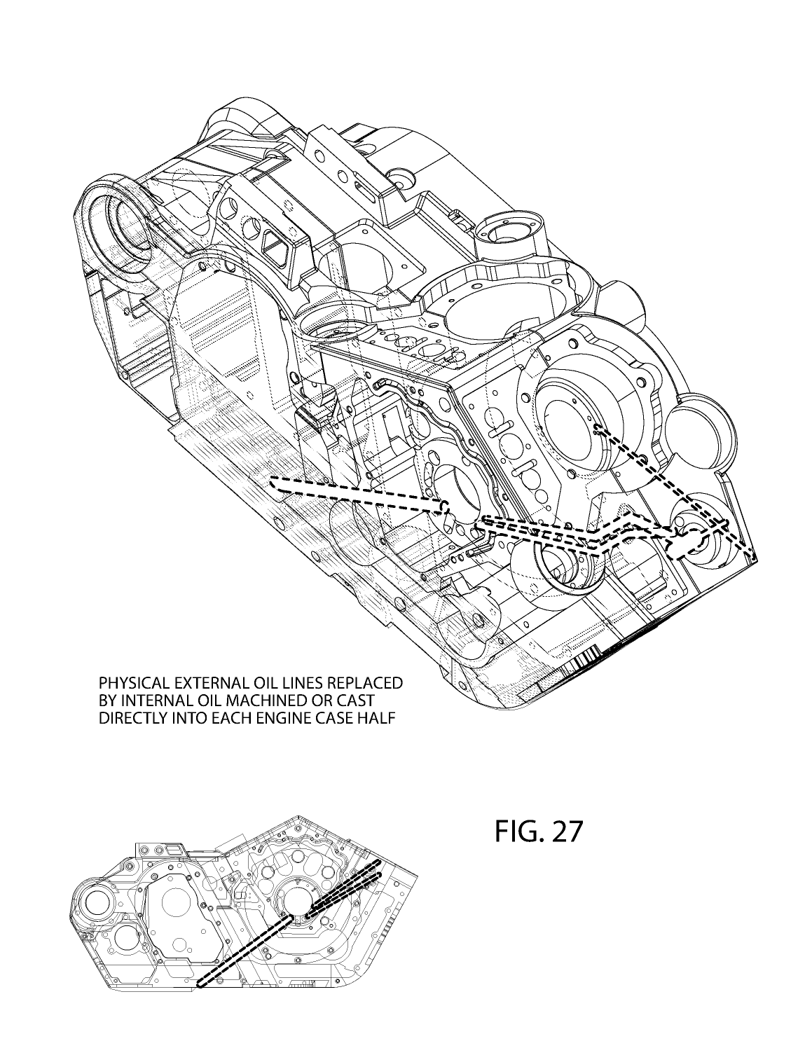

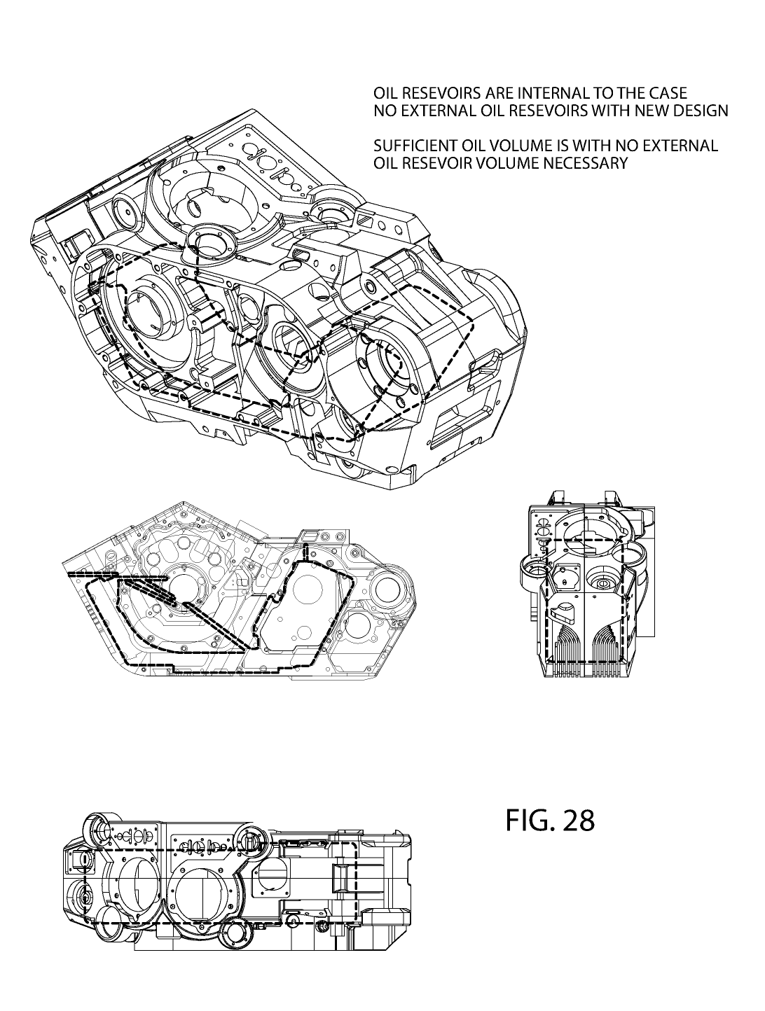

FIGS. 27 and 28 show a set of oil passages within the subassembly 700. In contrast to conventional motorcycles, all of the oil passages are internal to the subassembly 700. That is, there are no oil lines extending from the engine block, traversing an outside of the engine block, and then reconnecting to another location on the engine block. This configuration allows for use of less oil, and a more reliable oil supply and a source of leaks is removed.

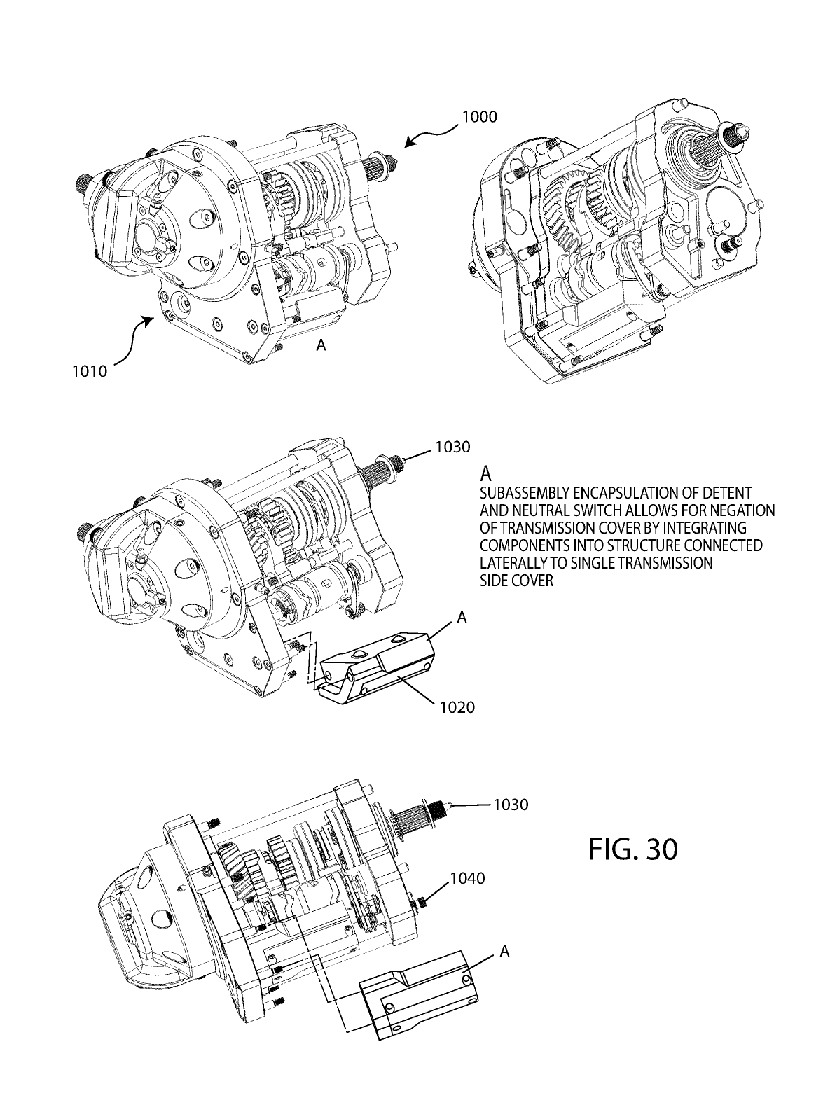

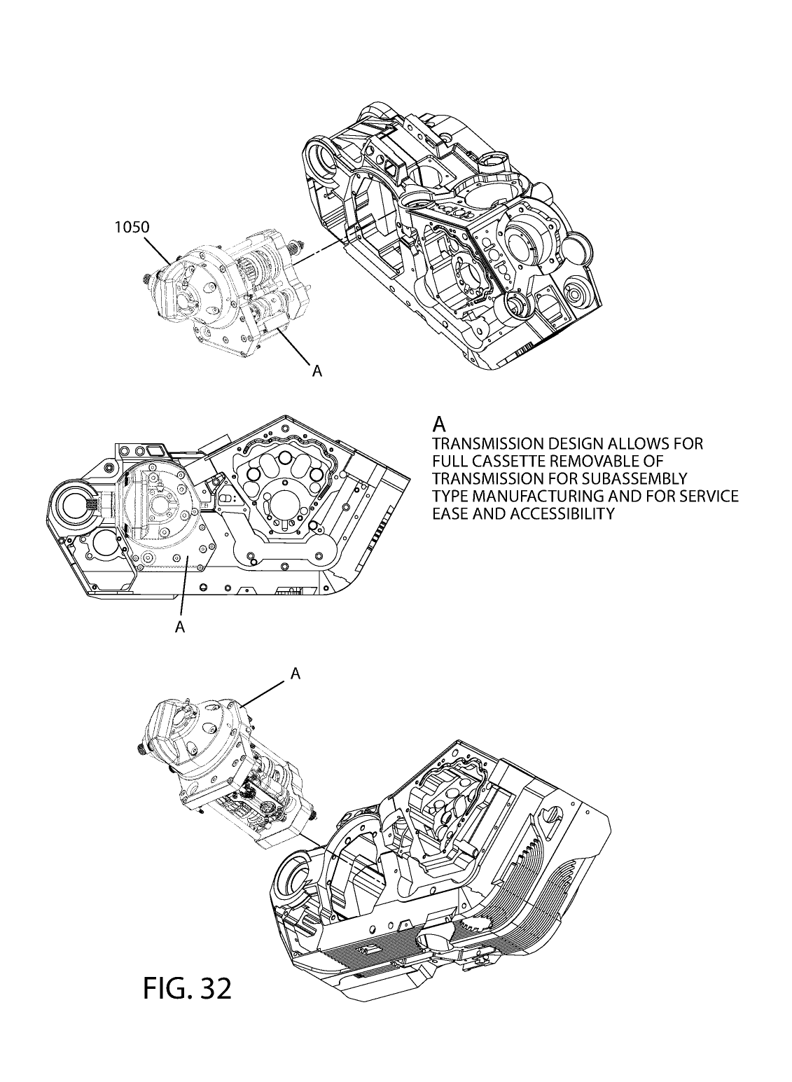

FIGS. 30 and 32 illustrate a transmission assembly 1000 of the motorcycle 10. The transmission assembly 1000 includes only a single side cover 1010, to which various transmission components are connected laterally. This configuration provides for omission of a second transmission cover, which saves space and weight. FIG. 30 also shows a small ratchet paw 1040 which is used to change gears, and a main shaft 1030 which interacts with a clutch drive. A subassembly 1020 encapsulates a detent and neutral switch into a component that can be attached to the single side cover 1010. This configuration also allows omission of a second side cover.

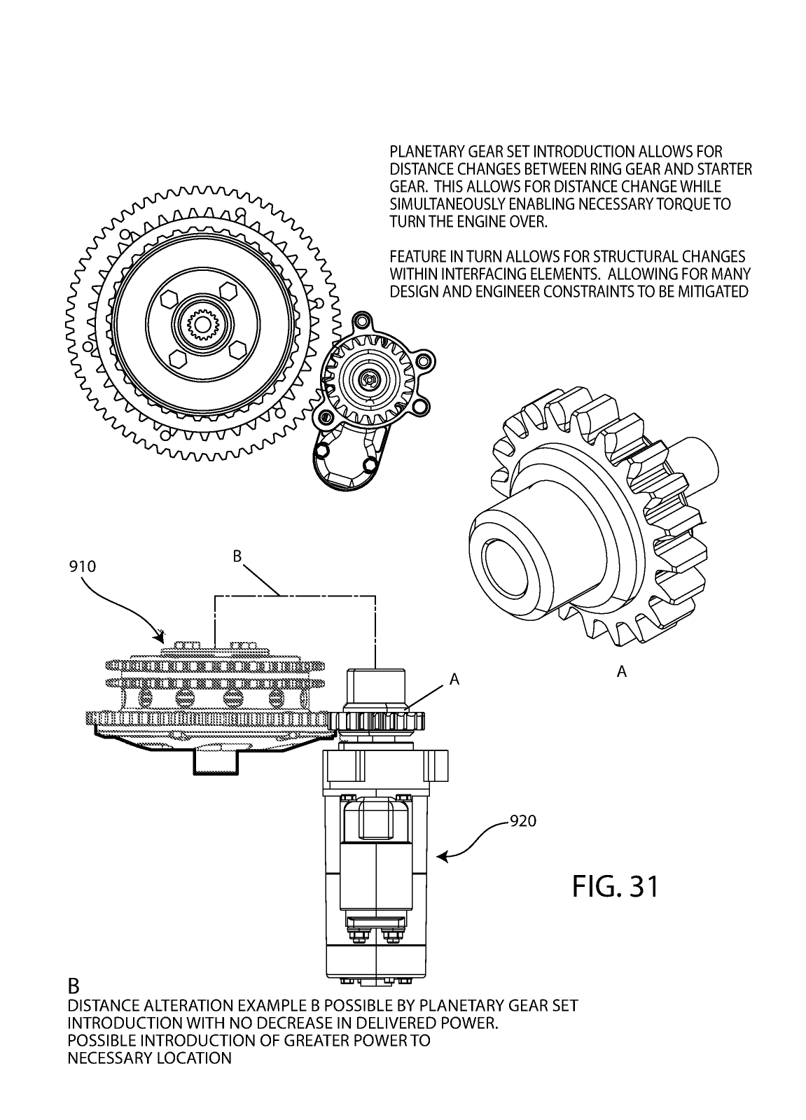

FIG. 31 shows a ring gear 915 of a planetary gear 910 of the motorcycle 10 directly engaged with a starter gear 920. This allows for omission of additional gears, and thus a flexibility to change a distance between the planetary gear 910 and the starter gear 920.

FIG. 32 shows the transmission assembly 1000 connected to a single side cover 1010. This configuration can be separately constructed and then installed into the motorcycle 10 and can be easily removed therefrom for maintenance. A left side bevel drive assembly 1050 is connected to a universal drive in a spline arm. This configuration allows commands from the spline arm to change the direction of power (i.e. put the motorcycle in reverse).

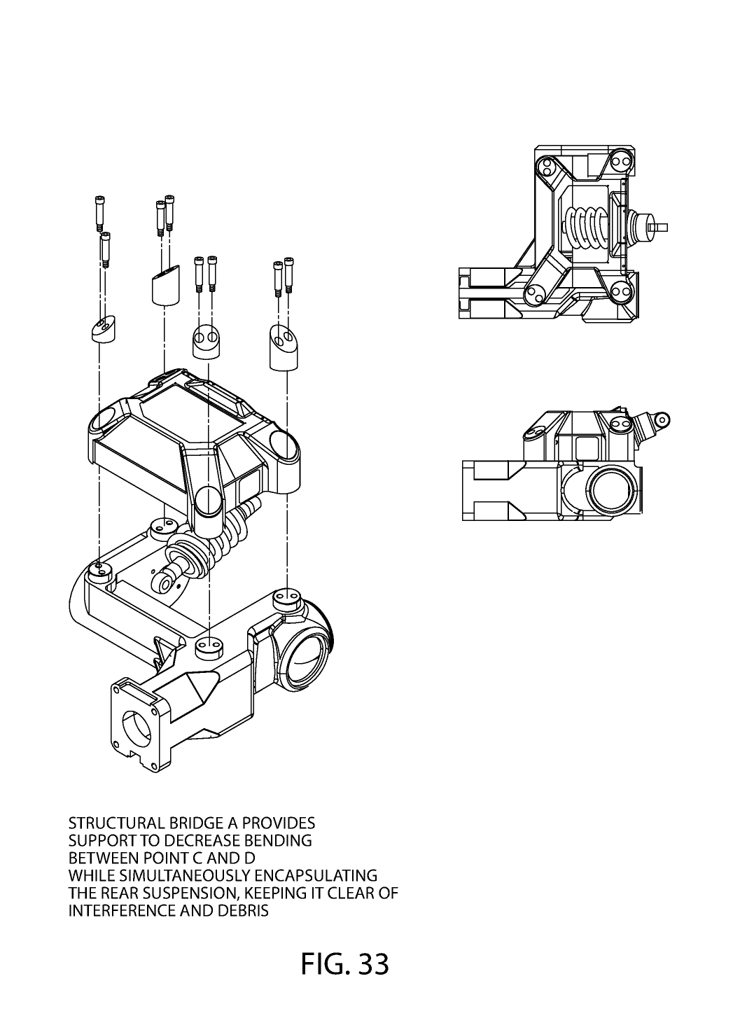

FIG. 33 shows a structural bridge A, which is connected to a top portion of the subassembly 700. The bridge A covers a rear suspension to keep the rear suspension free of debris, while also providing structural support to various extending portions of the subassembly 700 that connect to each side of the rear suspension.

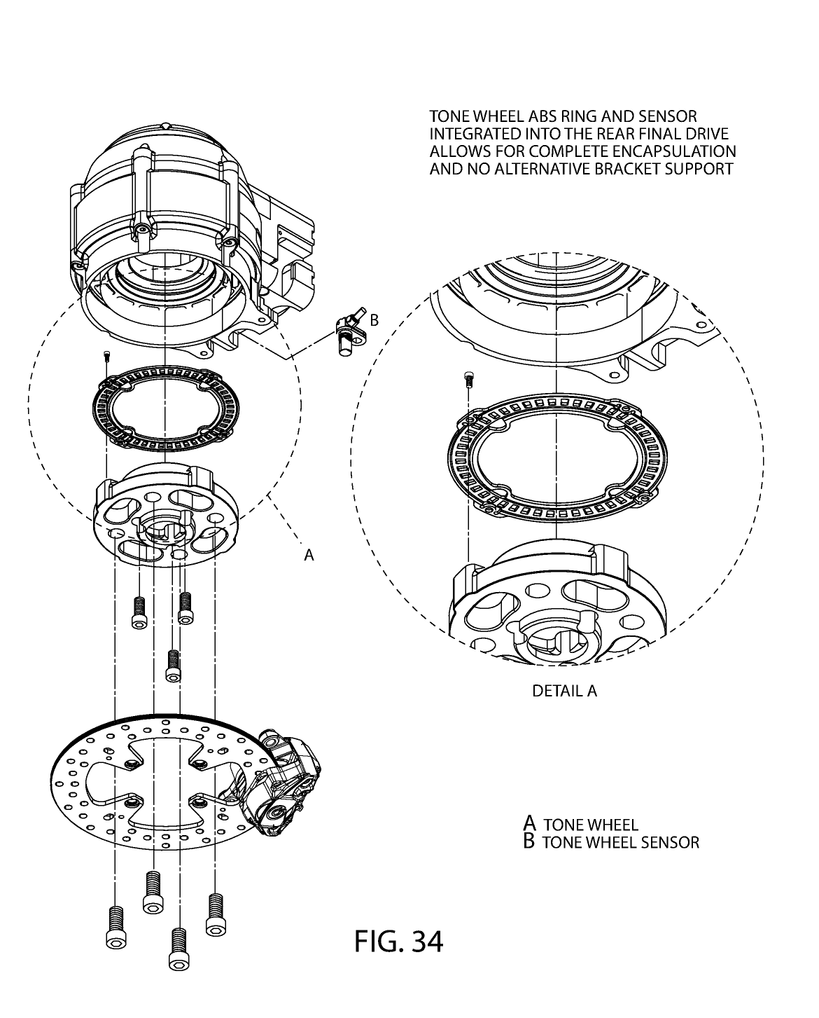

FIG. 34 shows a rear wheel assembly which includes an anti-lock braking (ABS) sensor B and a tone wheel A integrated into a drive subassembly. This configuration eliminates a need for conventional bracket supports for these components and allows complete encapsulation of these components by the drive subassembly.

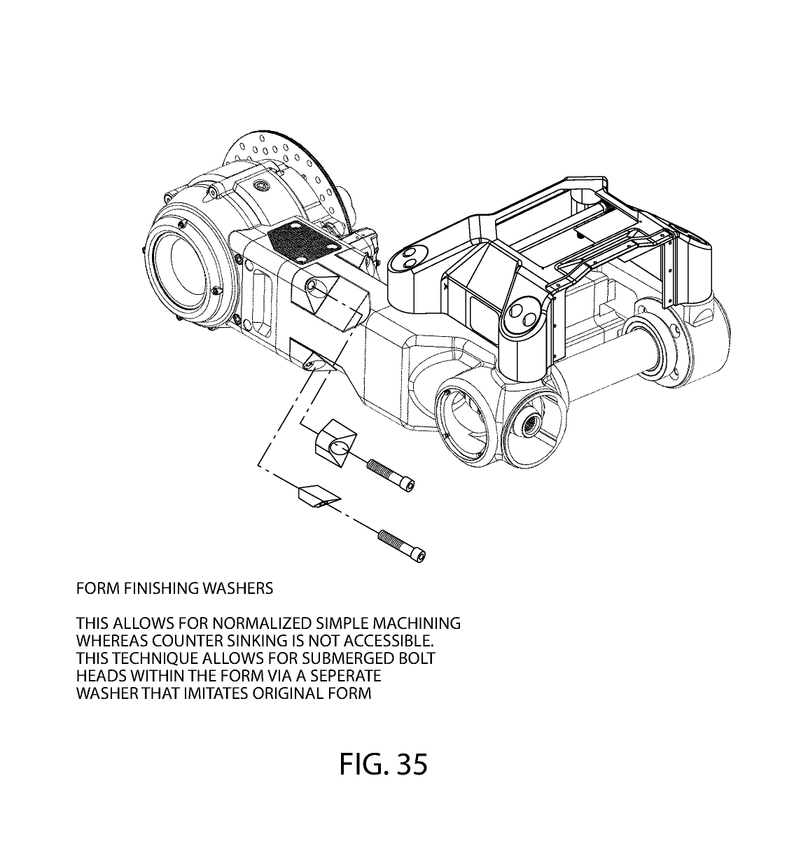

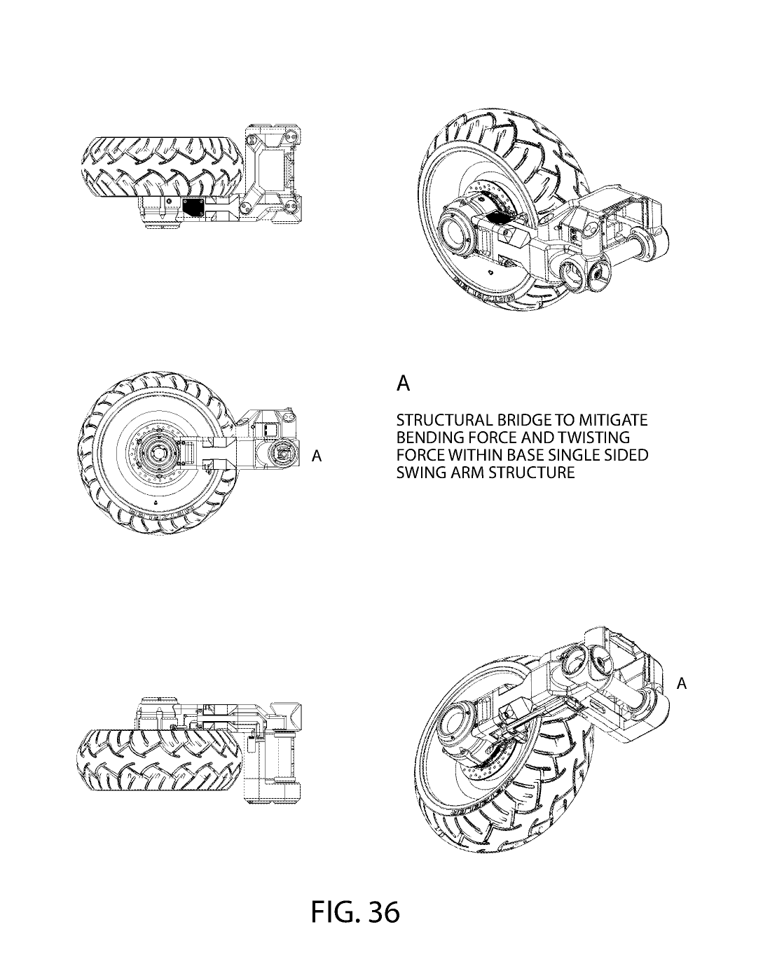

FIG. 36 shows a set of form finishing washers 701 used in the subassembly 700. The form finishing washers 701 allow for submerged bolt heads even when countersinking is not possible due to a geometry of a bolt location.

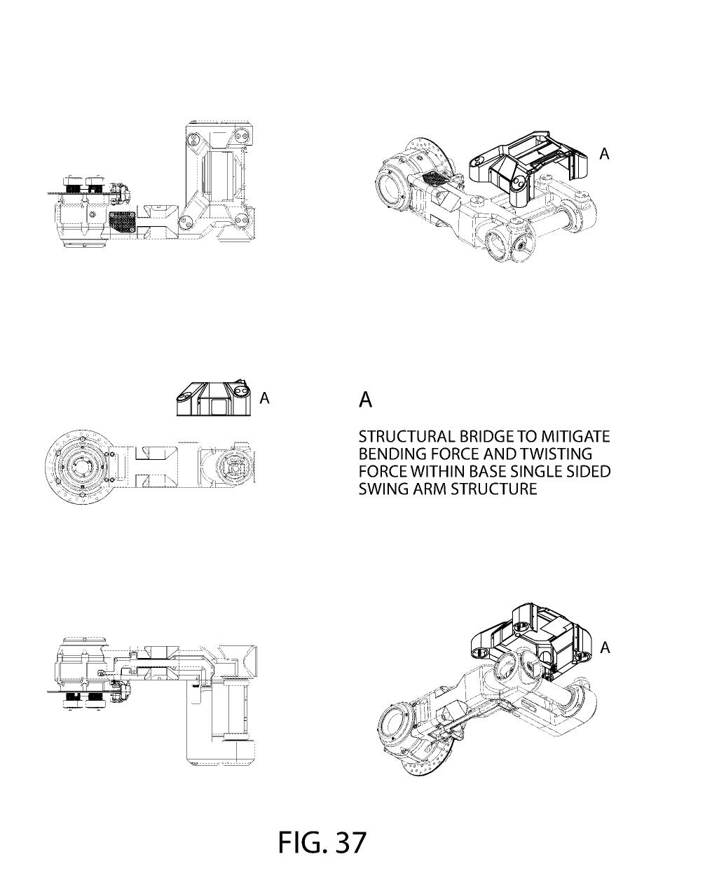

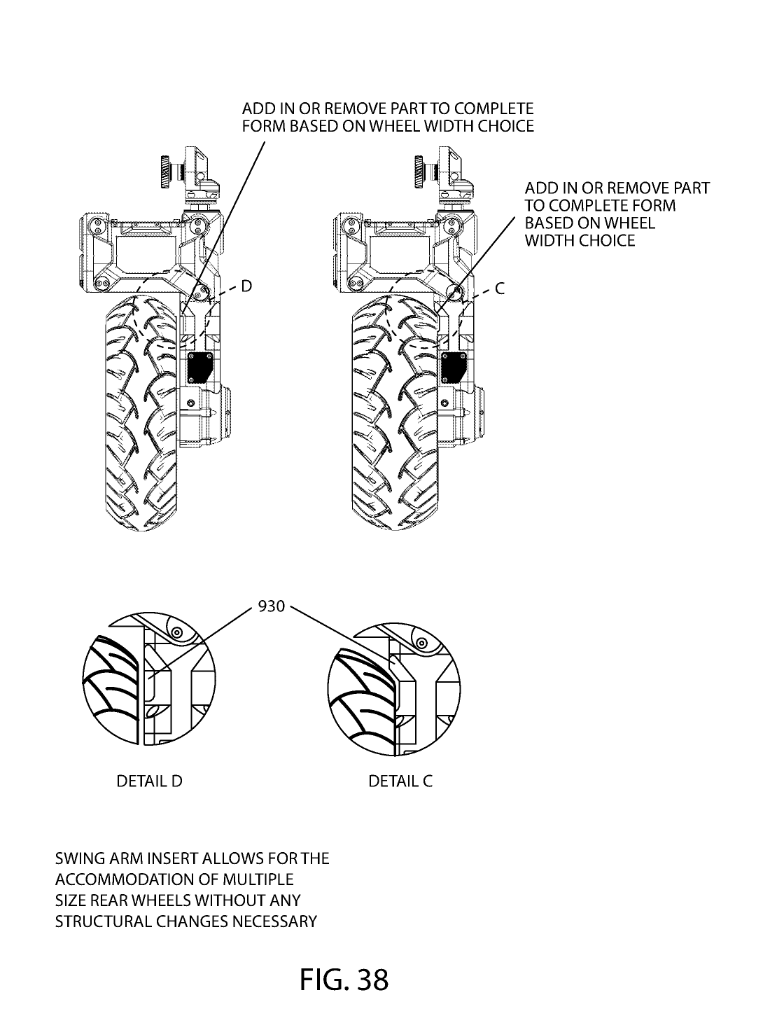

FIGS. 37 and 38 show a rear wheel assembly of subassembly 700. The rear wheel assembly includes a single sided rear arm structure with the structural bridge shown in FIG. 33.

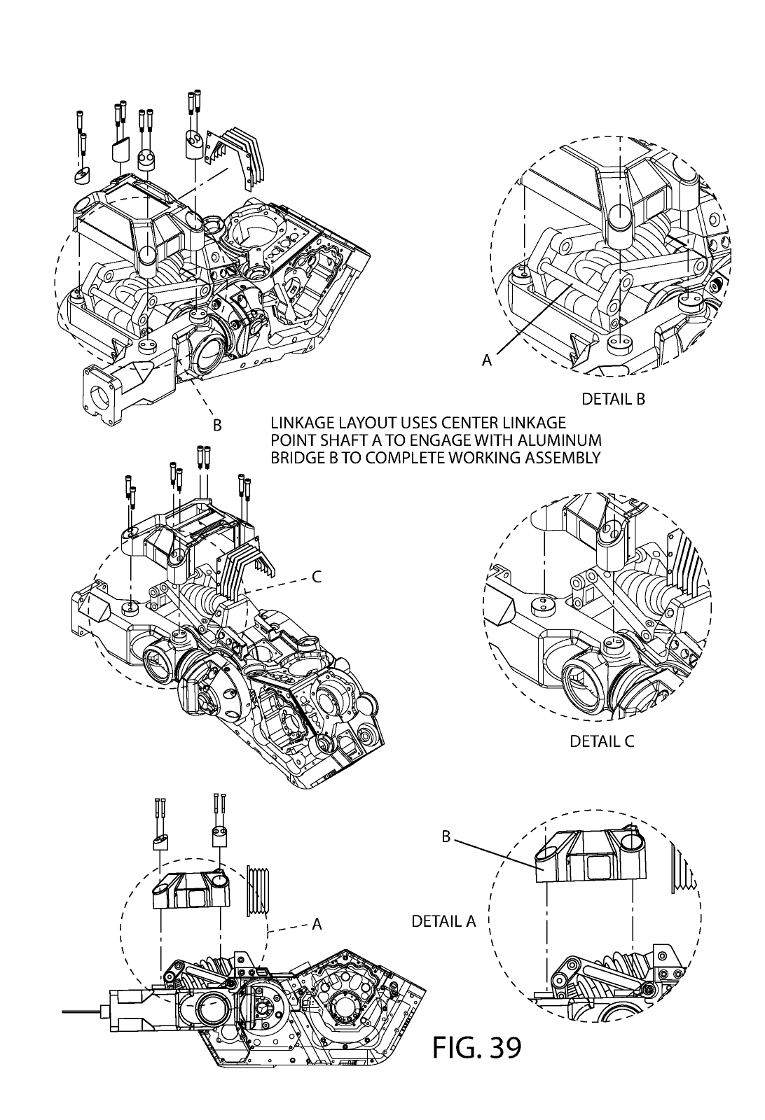

The single swing arm structure shown in FIG. 39 allows for installation of different sized rear wheels without any structural changes to the motorcycle 10. A set of form parts 980 can be swapped out for each other when different wheels are attached.

FIG. 40 shows an installation of the structural bridge shown in FIG. 33 to complete the subassembly 700.

In some embodiments, various functions or acts can take place at a given location and/or in connection with the operation of one or more apparatuses or systems. In some embodiments, a portion of a given function or act can be performed at a first device or location, and a remainder of the function or act can be performed at one or more additional devices or locations.

Various corresponding structures, materials, acts, and equivalents of all means or step plus function elements in various claims below are intended to include any structure, material, or act for performing the function in combination with other claimed elements as specifically claimed. Various embodiments were chosen and described in order to best explain various principles of this disclosure and various practical applications thereof, and to enable others of ordinary skill in a pertinent art to understand this disclosure for various embodiments with various modifications as are suited to a particular use contemplated.

Various diagrams depicted herein are illustrative. There can be many variations to such diagrams or steps (or operations) described therein without departing from various spirits of this disclosure. For instance, various steps can be performed in a differing order or steps can be added, deleted or modified. All of these variations are considered a part of this disclosure. People skilled in an art to which this disclosure relates, both now and in future, can make various improvements and enhancements which fall within various scopes of various claims which follow.

This detailed description has been presented for various purposes of illustration and description, but is not intended to be fully exhaustive and/or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. A scope of this disclosure is defined by various claims, which include known equivalents and unforeseeable equivalents at a time of filing of this disclosure.

What is claimed is:

1. A motorcycle comprising:
a front end subassembly including a fork, a suspension support, a shaft, an axle, and a wheel, wherein the suspension support is coupled to the fork, wherein the shaft is rigid, rectilinear, and extends from the suspension support such that the shaft is (1) parallel to the fork and (2) transverse to the axle, wherein the wheel rotates about the axle; and
a seat subassembly including a passenger seat, a gas tank, and a passage, wherein the gas tank is positioned between the passenger seat and the passage, wherein the shaft extends through the passage and thereby solely couples the front end subassembly to the seat subassembly such that the front end subassembly is able to steer the seat subassembly.

2. The motorcycle of claim 1, wherein the gas tank pivots about a first axis toward the passenger seat and away from the passenger seat between a first tank position and a second tank position, wherein the gas tank is longitudinally co-aligned with the passenger seat along a second axis when the gas tank is in the first tank position, wherein the second axis is non-perpendicular to the shaft, wherein the gas tank and the passenger seat define an internal obtuse angle when the gas tank is in the second tank position, wherein the first axis is parallel to the axle, wherein the first axis is not parallel the second axis.

3. The motorcycle of claim 2, wherein the seat assembly includes a work area that is hidden when the gas tank is in the first tank position and revealed when the gas tank is in the second tank position.

4. The motorcycle of claim 3, wherein the work area includes an air filter.

5. The motorcycle of claim 3, wherein the seat subassembly includes a display that pivots about a third axis toward the work area and away from the work area between a first display position and a second display position, wherein the third axis is parallel to the first axis, wherein the gas tank extends between the display and the work area when (1) the gas tank is in the first tank position and (2) the display is in the first display position, wherein the work area is positioned between the display and the gas tank when (1) the display is in the second display position and (2) the gas tank is in the second tank position.

6. The motorcycle of claim 1, further comprising:
a propulsion subassembly including an engine and a single sided rear arm structure, wherein the seat subassembly is removably fastened to the propulsion subassembly such that (1) the engine is positioned between the fork and the single sided rear arm structure and (2) the gas tank overlays the engine when the wheel is in contact with a ground surface.

7. The motorcycle of claim 6, wherein the passenger seat does not overlay the engine when the wheel is in contact with a ground surface.

8. The motorcycle of claim 7, wherein the seat subassembly is removably fastened to the propulsion subassembly via a plurality of fasteners extending from the seat subassembly to the propulsion assembly.

9. The motorcycle of claim 8, wherein the gas tank is positioned between the fasteners.

10. The motorcycle of claim 1, further comprising:
a lock bolt coupled to the shaft such that the front subassembly is removably secured to the seat subassembly.

11. A motorcycle comprising:
an actuator;
a turn signal configured to be rotated on an axis by the actuator and including a light that can be illuminated;
a seat assembly containing an opening configured to receive the turn signal when the turn signal is in a closed position; and
a turn signal controller configured to turn on the light and command the actuator to rotate the turn signal to a position outside of the opening.

12. A motorcycle comprising:
a passenger peg configured to be rotated on an axis to an open position; and
a seat assembly containing an opening configured to receive the passenger peg when the passenger peg is in a closed position.
